(19) United States
(12) Patent Application Publication
(10) Pub. No.: US 2026/0257904 A1
(43) Pub. Date: Sep. 3, 2026

(54) CAP ATTACHMENT-DETACHMENT DEVICE, PRE-PROCESSING DEVICE AND CAP ATTACHMENT METHOD

(71) Applicant: SHIMADZU CORPORATION, Kyoto (JP)

(72) Inventors: Mio TSUKAHARA, Kyoto (JP); Tadanobu SHIBABUKI, Kyoto (JP)

(73) Assignee: SHIMADZU CORPORATION, Kyoto (JP)

(21) Appl. No.: 18/879,757

(22) PCT Filed: Jun. 21, 2023
(86) PCT No.: PCT/JP2023/023031

§ 371 Date: Dec. 28, 2024

(30) Foreign Application Priority Data
Jul. 8, 2022 (JP) 2022-110713
Feb. 6, 2023 (JP) 2023-016422

(51) Int. Cl. B67B 3/20; B67B 7/18

(52) U.S. Cl. CPC B67B 3/20; B67B 7/182

(57) ABSTRACT

When a cap is attached to a container, an operation portion grips a cap while abutting against a top surface of the cap in which threads are formed, and causes the gripped cap to abut against the container. A buffer portion absorbs a pressing force to be applied from the cap to the operation portion. A controller sequentially executes control in which the cap gripped by the operation portion is fastened to the container by rotation of a rotation driver in a first direction, control in which the cap gripped by the operation portion is loosened from the container by rotation of the rotation driver in a second direction, and control in which the cap gripped by the operation portion is fastened to the container by rotation of the rotation driver in the first direction.

### TECHNICAL FIELD

The present invention relates to a cap attachment-detachment device, a pre-processing device and a cap attachment method.

### BACKGROUND ART

A pre-process may be executed on a sample with use of a container such as a centrifuge tube before the sample is analyzed in an analysis device. For example, in the pre-process, a sample to be analyzed and an additive are injected into a container having a cap, and then the contents of the container are stirred, etc. Thereafter, the contents are extracted from the container and injected into a predetermined vial. The contents including the pre-processed sample are supplied from the vial to the analysis device, so that a desired analysis is performed on the sample.

In the pre-process, before and after the contents are injected into the container, or before and after the contents are extracted from the container, the cap is attached and detached by a cap attachment-detachment device. For example, in a cap opening-closing device described in Patent Document 1, a sample container is gripped by a pair of grippers of a grip opening-closing driver, and a cap is gripped by a robot hand. In this state, the grip opening-closing driver is rotated, so that the cap is attached and detached.
[Patent Document 1] JP 03-226484 A

### SUMMARY OF INVENTION

### Technical Problem

In a case in which a container is not sealed, the contents leak from the container during the pre-process. Therefore, it causes problems such as contamination of the pre-processing device or degradation of accuracy of the pre-process. Therefore, in order to seal the container, it is necessary to accurately fit the cap to the container when the cap is attached. However, the cap or the container is not necessarily formed with high accuracy, and it is not easy to fit the cap to the container.

Further, in a case in which the cap is attached to the container with the cap and the container not properly fitted to each other, the frictional force between the cap and the container increases. Therefore, even when a torque is applied to the cap, idling between a robot hand and the cap may occur, and the cap may not be rotatable. In this case, the cap cannot be detached from the container, and the pre-process cannot be executed.

An object of the present invention is to provide a cap attachment-detachment device, a pre-processing device and a cap attachment method that enable reliably sealing of a container using a cap. Another object of the present invention is to provide a cap attachment-detachment device that enables reliable detachment of a cap from a container.

### Solution to Problem

One aspect of the present invention relates to a cap attachment-detachment device that includes a rotation driver that is rotatable in a first direction and a second direction that are opposite to each other, an operation portion that, when a cap is attached to a container, grips the cap while abutting against a top surface of the cap in which threads are formed, and causes the gripped cap to abut against the container, a transmitter that rotates the operation portion by transmitting rotation of the rotation driver to the operation portion, a buffer portion that, when the cap is attached to the container, absorbs a pressing force applied from the cap to the operation portion, and a controller that controls work of the rotation driver, wherein the controller, when the cap is attached to the container, sequentially executes first control in which the cap gripped by the operation portion is fastened to the container by rotation of the rotation driver in the first direction, second control in which the cap gripped by the operation portion is loosened from the container by rotation of the rotation driver in the second direction, and third control in which the cap gripped by the operation portion is fastened to the container by rotation of the rotation driver in the first direction.

Another aspect of the present invention relates to a pre-processing device that includes the above-mentioned cap attachment-detachment device that attaches a cap to and detaches the cap from a container, and a pre-processor that executes a pre-process on a sample contained in the container.

Yet another aspect of the present invention relates to a cap attachment method that is executed by a cap attachment-detachment device, that includes gripping a cap using an operation portion while causing the operation portion to abut against a top surface of the cap in which threads are formed, absorbing a pressing force to be applied from the cap to the operation portion using a buffer portion while causing the cap gripped by the operation portion against a container, fastening the cap gripped by the operation portion to the container by rotating a rotation driver in a first direction, applying a pressing force absorbed by the buffer portion to the top surface of the cap while loosening the cap gripped by the operation portion from the container by rotating the rotation driver in a second direction opposite to the first direction after the cap is fastened to the container, and fastening the cap gripped by the operation portion to the container by rotating the rotation driver in the first direction after the cap is loosened from the container.

Yet another aspect of the present invention relates to a cap attachment-detachment device that includes a rotation driver that is rotatable in a predetermined direction, an operation portion including a grip portion having a pointed tip, a transmitter that rotates the operation portion by transmitting rotation of the rotation driver to the operation portion, and a controller that, when a cap is detached from a container, controls work of the operation portion such that the tip of the grip portion abuts against the cap in which threads are formed.

Yet another aspect of the present invention relates to a cap attachment-detachment deice that includes a rotation driver that is rotatable in a first direction and a second direction that are opposite to each other, an operation portion that, when a cap is attached to a container, grips the cap in which threads are formed and causes the gripped cap to abut against the container, a transmitter that rotates the operation portion by transmitting rotation of the rotation driver to the operation portion, and a controller that, when the cap is attached to the container, controls work of the rotation driver such that the operation portion rotates in the first direction and the cap is fastened to the container, wherein the controller further controls work of the operation portion such that, after the cap is fastened to the container, control in which the operation portion rotates in the second direction and the cap is detached from the container and control in which the operation portion rotates in the first direction and the cap is fastened to the container again, are executed once or more.

Yet another aspect of the present invention relates to a cap attachment method executed by a cap attachment-detachment device that includes gripping a cap in which threads are formed and causing the cap to abut against a container, fastening the cap gripped by the operation portion to the container by rotating a rotation driver in a first direction, and performing adjusting work for adjusting the cap to the container, wherein the adjusting work includes, after the cap is fastened to the container, rotating the operation portion in a second direction opposite to the first direction to detach the cap from the container and rotating the operation portion in the first direction to fasten the cap to the container again, once or more.

### Advantageous Effects of Invention

With the present invention, a cap can reliably seal a container. Further, the cap can be reliably detached from the container.

### BRIEF DESCRIPTION OF THE DRAWINGS

FIG. 1 is a block diagram showing a pre-processing device according to a first embodiment.

FIG. 2 is a schematic diagram showing the configuration of a cap attachment-detachment device of FIG. 1.

FIG. 3 is a diagram for explaining the work for attaching a cap performed by the cap attachment-detachment device.

FIG. 4 is a diagram for explaining the work for attaching the cap performed by the cap attachment-detachment device.

FIG. 5 is a diagram for explaining the work for attaching the cap performed by the cap attachment-detachment device.

FIG. 6 is a diagram for explaining the work for attaching the cap performed by the cap attachment-detachment device.

FIG. 7 is a diagram for explaining the work for attaching the cap performed by the cap attachment-detachment device.

FIG. 8 is a diagram for explaining the work for detaching the cap performed by the cap attachment-detachment device.

FIG. 9 is a diagram for explaining the work for detaching the cap performed by the cap attachment-detachment device.

FIG. 10 is a diagram for explaining the work for detaching the cap performed by the cap attachment-detachment device.

FIG. 11 is a diagram showing the configuration of a controller.

FIG. 12 is a flowchart showing one example of the algorithm of an attachment-detachment process executed by the controller.

FIG. 13 is an enlarged view showing a portion of a grip portion in a second embodiment.

FIG. 14 is a diagram for explaining the work of the grip portion.

FIG. 15 is a diagram for explaining the work of the grip portion.

FIG. 16 is a diagram for explaining the work of the grip portion.

FIG. 17 is a diagram showing the configuration of a controller in the second embodiment.

FIG. 18 is a flowchart showing one example of the algorithm of an attachment-detachment process in the second embodiment.

FIG. 19 is a diagram for explaining the work for detaching the cap in a reference example.

FIG. 20 is a diagram for explaining the work for detaching the cap having a lip seal type.

FIG. 21 is a diagram showing the configuration of a controller in a third embodiment.

FIG. 22 is a flowchart showing one example of the algorithm of an attachment-detachment process in the third embodiment.

FIG. 23 is a diagram showing a container and a cap when the cap is fastened to the container.

FIG. 24 is a diagram showing the container and the cap when the adjusting work is performed.

### DESCRIPTION OF EMBODIMENTS

### 1. First Embodiment

### (1) Pre-processing Device

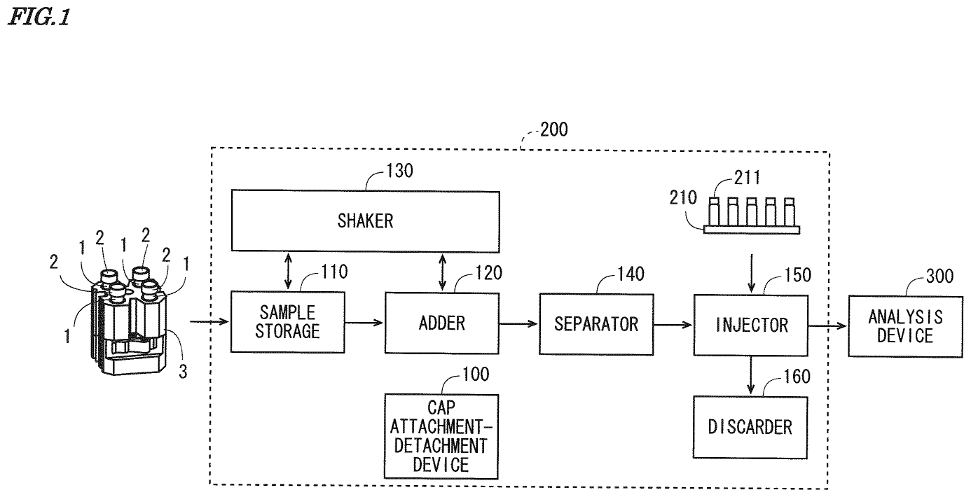

A cap attachment-detachment device, a pre-processing device and a cap attachment method according to embodiments of the present invention will be described below in detail with reference to the drawings. FIG. 1 is a block diagram showing a pre-processing device according to a first embodiment. As shown in FIG. 1, the pre-processing device 200 includes a sample storage 110, an adder 120, a shaker 130, a separator 140, an injector 150 and a discarder 160. A cap attachment-detachment device 100 is provided in each of the sample storage 110, the adder 120 and the injector 150.

Container holding racks 3 each of which holds a plurality of containers 1 are sequentially introduced into the pre-processing device 200. In the present example, a container holding rack 3 holds four containers 1 arranged in two rows and two columns. Each container 1 is a centrifuge tube, for example. By operating screw-type caps (screw caps) 2 of the plurality of containers 1, the cap attachment-detachment device 100 is configured to be capable of attaching the caps 2 to the upper ends of the plurality of containers 1 at the same time and detaching the caps 2 from the upper ends of the plurality of containers 1 at the same time. Details of the cap attachment-detachment device 100 will be described below.

After detaching the cap 2 from each container 1 of the introduced container holding rack 3, the sample storage 110 stores a sample to be analyzed in each container 1 and attaches the cap 2 to each container 1. The sample to be analyzed includes food, for example. Thereafter, the sample storage 110 carries the container holding rack 3 into the shaker 130, and carries the container holding rack 3 that has been carried in from the shaker 130 into the adder 120.

After detaching the cap 2 from each container 1 of the container holding rack 3 that has been carried in from the sample storage 110, the adder 120 adds a predetermined solvent, an internal standard reagent or the like to each container 1 and attaches the cap 2 to each container 1. Thereafter, the adder 120 carries the container holding rack 3 into the shaker 130 and carries the container holding rack 3 that has been carried in from the shaker 130 into the separator 140.

After stirring the contents of each container 1 by shaking the container 1 of the container holding rack 3 that has been carried in from the sample storage 110, the shaker 130 carries the container holding rack 3 into the sample storage 110. Further, after stirring the contents of each container 1 by shaking the container 1 of the container holding rack 3 that has been carried in from the adder 120, the shaker 130 carries the container holding rack 3 into the adder 120.

The separator 140 separates the contents of each container 1 into components by applying a centrifugal force to the container holding rack 3 that has been carried in from the adder 120. Thereafter, the separator 140 carries the container holding rack 3 into the injector 150. The adder 120, the shaker 130 or the separator 140 is an example of a pre-processor that executes a pre-process on samples contained in the plurality of containers 1.

Vial racks 210 each of which holds a plurality of vials 211 for an analysis are sequentially introduced into the injector 150. After detaching the cap 2 from each container 1 of the container holding rack 3 that has been carried in from the separator 140, the injector 150 extracts part of the contents from each container 1 of each container 1 and injects the extracted contents into each vial 211 of the vial rack 210. Thus, the contents including pre-processed samples are contained in each vial 211.

Thereafter, the injector 150 attaches the cap 2 to each container 1 of the container holding rack 3 and carries the container holding rack 3 into the discarder 160. Further, the injector 150 carries the vial rack 210 into the analysis device 300. The discarder 160 discards the contents of each container 1 of the container holding rack 3 that has been carried in from the injector 150.

The analysis device 300 performs a predetermined analysis on the contents of each vial 211 of the vial rack 210 that has been carried in from the pre-processing device 200. An analysis includes quantitative determination of pesticide residue in food, which is a sample, for example. The analysis device 300 may be a liquid chromatograph mass spectrometer (LC/MS), a gas chromatograph mass spectrometer (GC/MS) or another analysis device, for example.

In each of the sample storage 110, the adder 120 and the injector 150 of the pre-processing device 200, it is possible to attach and detach the cap 2 properly and efficiently by using the cap attachment-detachment device 100. Thus, the throughput can be improved. Further, it can save human labor.

### (2) Configuration of Cap Attachment-Detachment Device

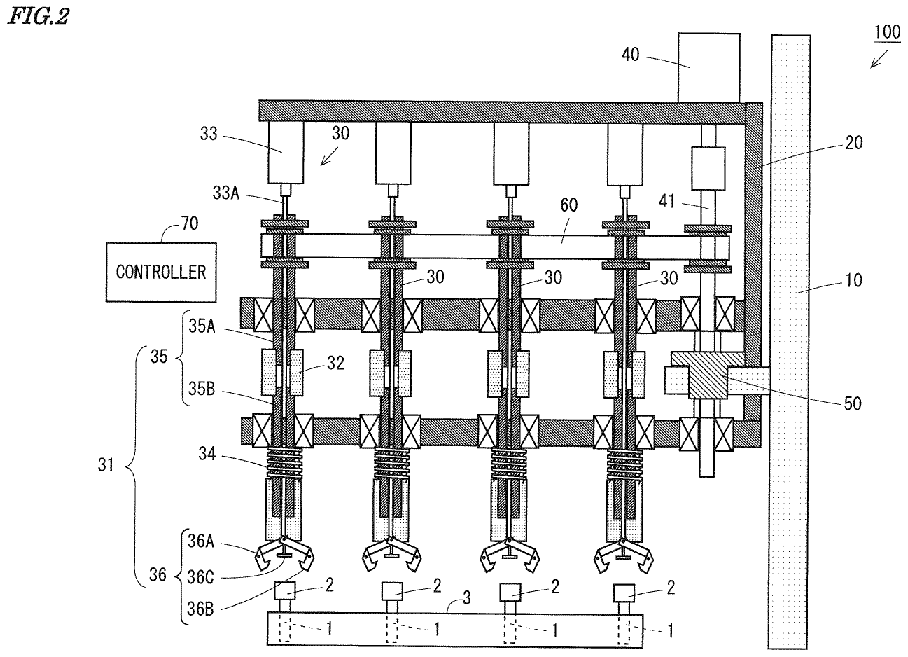

FIG. 2 is a schematic diagram showing the configuration of the cap attachment-detachment device 100 of FIG. 1. As shown in FIG. 2, a base portion 10, a holder 20, a plurality of attachment-detachment portions 30, a rotation driver 40, a mover 50, a transmitter 60 and a controller 70 are included. In FIG. 2, the plurality of containers 1 held in the container holding rack 3 are shown so as to be arranged in a leftward-and-rightward direction for facilitation of understanding. Therefore, the plurality of attachment-detachment portions 30 corresponding to the plurality of containers 1 are also shown so as to be arranged in the leftward-and-rightward direction.

The base portion 10 is attached to the installation surface of the cap attachment-detachment device 100. The holder 20 holds the plurality of attachment-detachment portions 30. Each attachment-detachment portion 30 includes an operation portion 31, a restricting portion 32, an opening-closing portion 33 and a buffer portion 34. The operation portion 31 includes a driven portion 35 and a grip portion 36. The driven portion 35 has an axis extending in an upward-and-downward direction and includes driven members 31A, 31B that are rotatable about the axis. The driven members 35A, 35B are examples of first and second driven members, respectively. The driven member 31B is arranged below the driven member 35A.

The restricting portion 32 connects the driven member 35A and the driven member 35B to each other such that a torque generated when the driven member 35A rotates is transmittable to the driven member 35B. The restricting portion 32 includes a one-way friction clutch, for example, and restricts the torque to be transmitted to the driven member 35B to a value equal to or smaller than a prescribed value when the driven member 35A rotates in a forward direction (clockwise direction, for example). The prescribed value of torque is adjustable. On the other hand, the restricting portion 32 does not restrict a torque to be transmitted to the driven member 35B when the driven member 35A is rotates in a reverse direction (counterclockwise direction, for example).

The grip portion 36 has a pair of grip claws 36A, 36B which can be opened and closed, and a pressing member 36C. The grip claws 36A, 36B are connected to the lower end of a drive shaft 33A of the opening-closing portion 33, described below. The pressing member 36C has a disk shape, for example. While the pressing member 36C has a disc shape in the above-mentioned embodiment, the embodiment is not limited to this. The pressing member 36C may have a polygonal-plate shape such as a triangular-plate shape or a quadrangular-plate shape. Alternatively, the pressing member 36C may have a bar shape extending in the upward-and-downward direction, and a plurality of pressing members 36C may be provided.

Between the grip claws 36A, 36B, the pressing member 33C is connected to the lower end of the drive shaft 33A so as to be rotatable with respect to the drive shaft 33A of the opening-closing portion 33. The grip claws 36A, 36B are closed with the top surface of the cap 2 being in contact with the bottom surface of the pressing member 36C, so that the cap 2 is gripped. In this state, the grip portion 36 is rotated, so that the cap 2 is attached to and detached from the container 1.

The opening-closing portion 33 includes an air cylinder, for example, and has the drive shaft 33A. The opening-closing portion 33 is fixed to an upper portion of the holder 20, for example. The lower end portion of the drive shaft 33A is connected to the grip claws 36A, 36B and the pressing member 33C while being inserted through the center of the driven portion 35. The opening-closing portion 33 drives the drive shaft 33A, thereby opening and closing the grip claws 36A, 36B of the grip portion 36. The opening-closing portion 33 may include another actuator such as a solenoid.

The buffer portion 34 includes a spring member, for example, and holds the grip portion 36 at a lower portion of the driven member 35B such that the grip portion 36 is movable in the upward-and-downward direction with respect to the driven portion 35 and a torque generated when the driven member 35B rotates is transmittable to the grip portion 36. With this configuration, in a case in which an upward pressing force equal to or larger than a predetermined value is applied from the cap 2 to a lower portion of the grip portion 36, the pressing force of the grip portion 36 is absorbed by upward movement of the grip portion 36.

The rotation driver 40 includes a single actuator such as an electric motor and has a rotation shaft 41. The rotation driver 40 is fixed to the holder 20, for example. The mover 50 includes a linear-motion ball screw member, for example, and is connected to the base portion 10 and the holder 20. The pitch of the linear-motion ball screw member is the same as the pitch of the cap 2. The rotation shaft 41 of the rotation driver 40 is attached to the mover 50. In response to rotation of the rotation driver 40, the mover 50 moves the holder 20 in the upward-and-downward direction with respect to the base portion 10.

The transmitter 60 is a belt member, for example, and is looped around the driven members 35A of the driven portions 35 of the plurality of attachment-detachment portions 30 and the rotation shaft 41 of the rotation driver 40. Thus, the rotation of the rotation driver 40 is transmitted to the plurality of driven members 35A. Each operation portion 31 is moved in a downward direction and an upward direction in response to the rotation of the rotation driver 40, and rotates the cap 2 so as to attach the cap 2 to and detach the cap 2 from the corresponding container 1. The controller 70 includes a CPU and a memory, and controls the work of the opening-closing portion 33 of the attachment-detachment portion 30 and the work of the rotation driver 40. The work of the cap attachment-detachment device 100 will be described below.

### (3) Cap Attachment Work

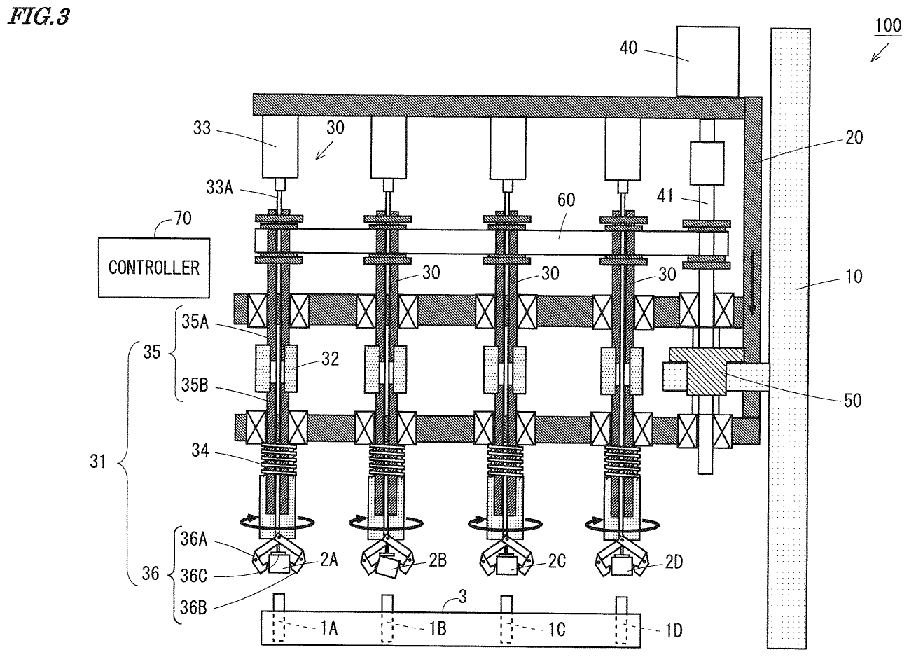

FIGS. 3 to 7 are diagrams for explaining the work for attaching the cap 2 performed by the cap attachment-detachment device 100. As shown in FIG. 3, when the cap 2 is attached, the grip portion 36 of the attachment-detachment portion 30 closes the grip claws 36A, 36B, thereby being located above the corresponding container 1 while gripping the cap 2. In the following description, in a case in which four caps 2 are to be distinguished from one another, the four caps 2 are respectively referred to as caps 2A to 2D. Further, the containers 1 corresponding to the caps 2A to 2D are referred to as containers 1A to 1D, respectively.

In the example of FIG. 3, each of the caps 2A, 2C, 2D is gripped in a horizontal posture by being in contact with the surface of the pressing member 36C of the corresponding attachment-detachment portion 30. On the other hand, the cap 2B is gripped in an inclined posture without being in contact with the surface of the pressing member 36C of the corresponding attachment-detachment portion 30. The term “horizontal” means that the axis of the threads of the cap 2 is parallel to the axis of the corresponding threads of the container 1. The term “inclined” means that the axis of the threads of the cap 2 is not parallel to the axis of the corresponding threads of the container 1.

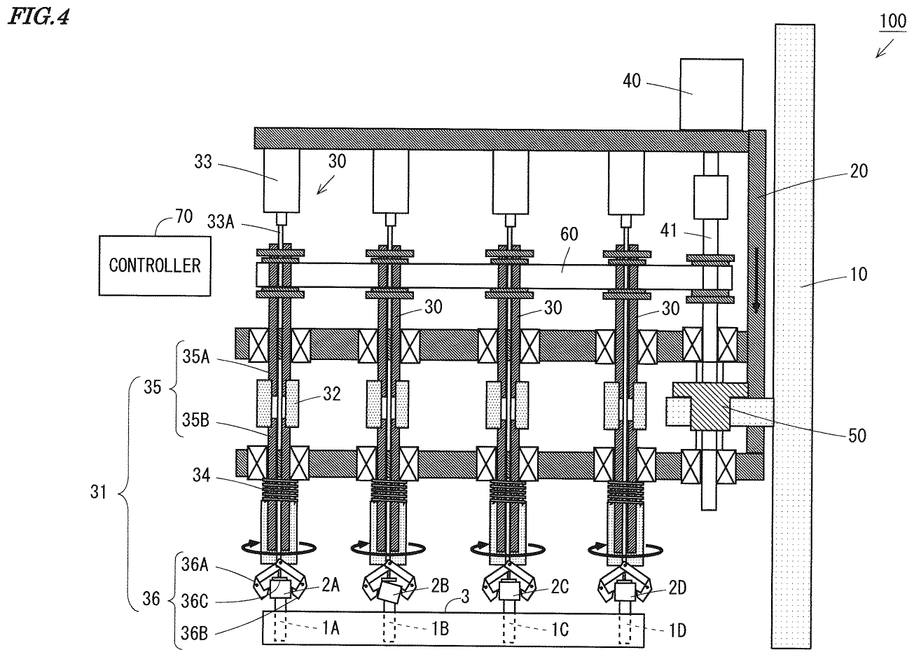

When the rotation driver 40 rotates in the forward direction, the grip portion 36 of the attachment-detachment portion 30 moves downwardly together with the movement of the holder 20 while rotating. The forward direction is an example of a first direction. Thus, as shown in FIG. 4, the cap 2 gripped by the grip portion 36 abuts against the upper end of the container 1. In this case, an upward pressing force is applied to a lower portion of the grip portion 36, so that the buffer portion 34 contracts, and the grip portion 36 is slightly upwardly displaced.

In this state, the forward rotation of the grip portion 36 is continued. Thus, the caps 2A, 2C, 2D are respectively fastened to the containers 1A, 1C, 1D. The control executed by the controller 70 at this time is an example of first control. On the other hand, because the cap 2B is gripped while being inclined, the threads of the cap 2B and the threads of the container 1A do not fit properly. Therefore, the cap 2B is not properly fastened to the container 1B. When a pre-process such as shaking or centrifugation is executed on the container 1B in this state, liquid leakage may occur.

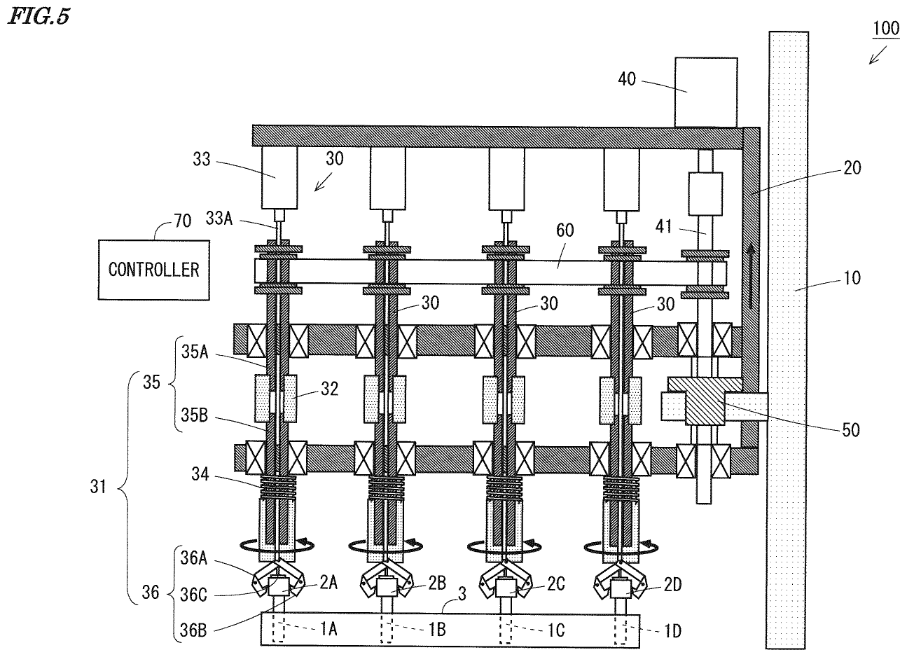

As such, as shown in FIG. 5, the rotation driver 40 is rotated in the reverse direction by a predetermined angle. The reverse direction is an example of a second direction. The rotation angle by which the rotation driver 40 rotates in the reverse direction at this time is equal to or larger than the pitch angle of the threads of the cap 2, and is an angle that is predetermined such that the cap 2 is not separated from the container 1. The pitch angle is a rotation angle that is necessary for advancement for one thread, and is 360 degrees in a case in which the screw of the cap 2 is a single-thread screw, and is 180 degrees in a case in which the screw of the cap 2 is a double-thread screw.

The rotation driver 40 rotates in the reverse direction, so that the attachment-detachment portion 30 is slightly lifted together with the holder 20. The control executed by the controller 70 at this time is an example of second control. In this case, a restoring force of the contracted buffer portion 34 is applied to the top surface of the cap 2B through the pressing member 36C. Thus, the top surface of the cap 2B is pressed by the bottom surface of the pressing member 36C, so that the cap 2B comes into contact with the surface of the pressing member 36C. Therefore, the posture of the cap 2B gripped by the grip portion 36 is horizontal.

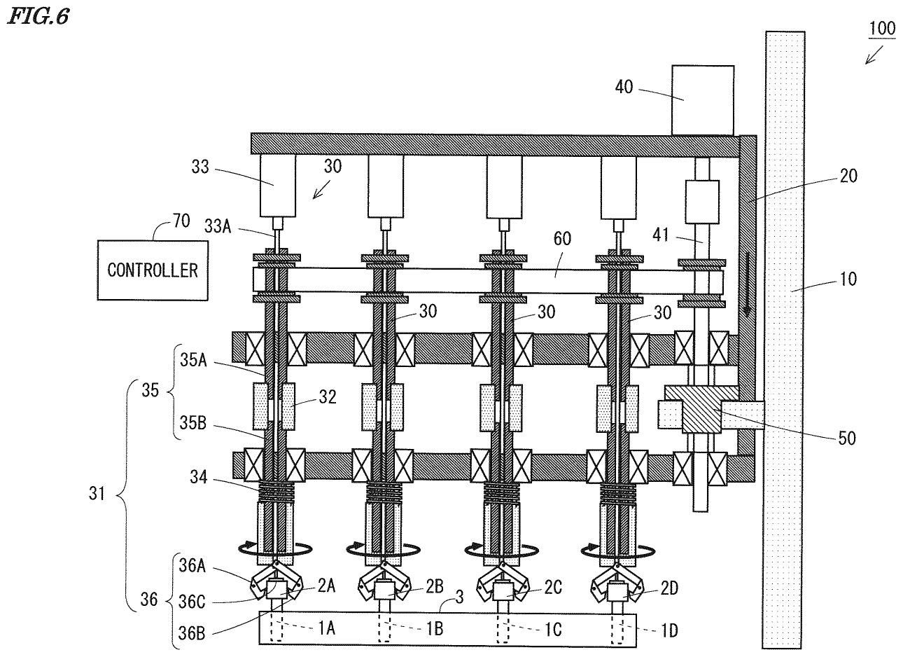

Thereafter, as shown in FIG. 6, the rotation driver 40 is rotated again in the forward direction, so that the caps 2A to 2D are respectively fastened to the containers 1A to 1D. The control executed by the controller 70 at this time is an example of third control. The rotation angle in the forward direction in the third control may be equal to or larger than the rotation angle in the second control. In the fastening work, when a torque obtained when the driven member 31A rotates in the forward direction reaches a prescribed value, the driven member 31B idles due to the restricting portion 32, and thus the cap 2A to 2D can be fastened uniformly.

With the above-mentioned control, the caps 2A to 2D in a horizontal posture are attached to the containers 1A to 1D at the same time. Further, even in a case in which the plurality of containers 1A to 1D have dimensional variations due to individual differences, the caps 2 are respectively fastened to the corresponding containers 1 with the caps 2A to 2D and the containers 1A to 1D properly respectively fitted to each other. Thus, each cap 2 can reliably seal the corresponding container 1.

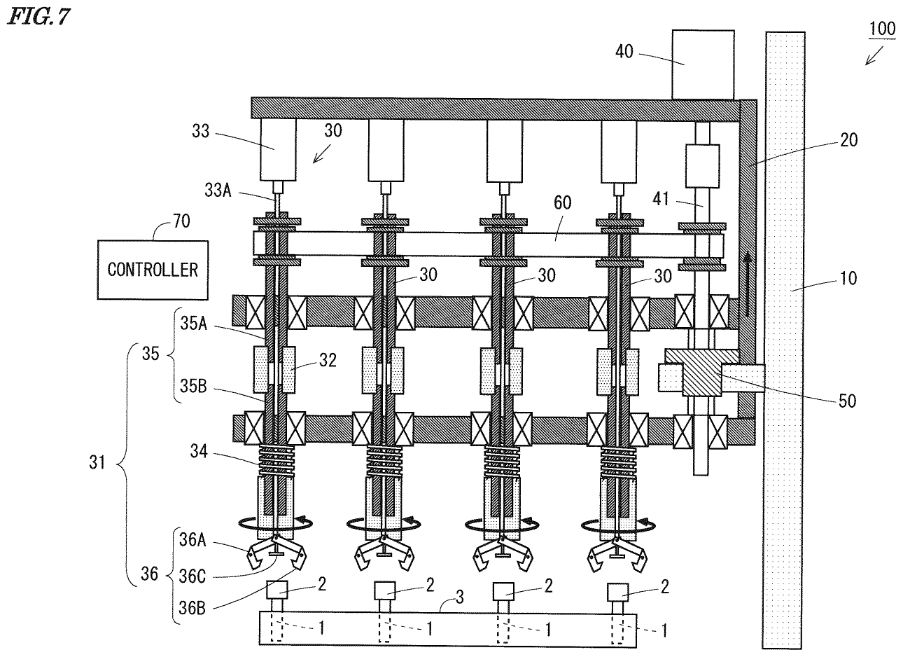

After the cap 2 is attached to the container 1, the grip claws 36A, 36B of each grip portion 36 are opened as shown in FIG. 7. Thus, gripping of the cap 2 by the grip portion 36 is released. Thereafter, the rotation driver 40 rotates in the reverse direction. In this case, with the grip portion 36 not gripping the cap 2, the holder 20 is moved upwardly with respect to the base portion 10 by the mover 50. Thus, the work for attaching the cap 2 ends.

In the fastening work of FIG. 4, due to dimensional variations of the plurality of containers 1 caused by individual differences, points in time at which the plurality of caps 2 respectively abut against the upper ends of the containers 1 vary. Therefore, in regard to the container 1 the upper end of which is located at an uppermost position, fastening starts earlier than the other containers 1. On the other hand, in regard to the container 1 the upper end of which is located at a lowermost position, fastening starts later than the other containers 1.

Even in this case, the grip portion 36 is held by the buffer portion 34 so as to be movable in the upward-and-downward direction with respect to the driven portion 35. Therefore, in a case in which an upward pressing force is applied to a lower portion of each grip portion 36 due to abutment of the cap 2 against the container 1, the pressing force of the grip portion 36 is absorbed by upward movement of each grip portion 36. Further, when a torque generated when the driven member 35A rotates in the forward direction reaches a prescribed value, the driven member 35A idles with respect to the driven member 35B due to the restricting portion 32. Thus, the plurality of caps 2 can be fastened uniformly.

### (4) Cap Detachment Work

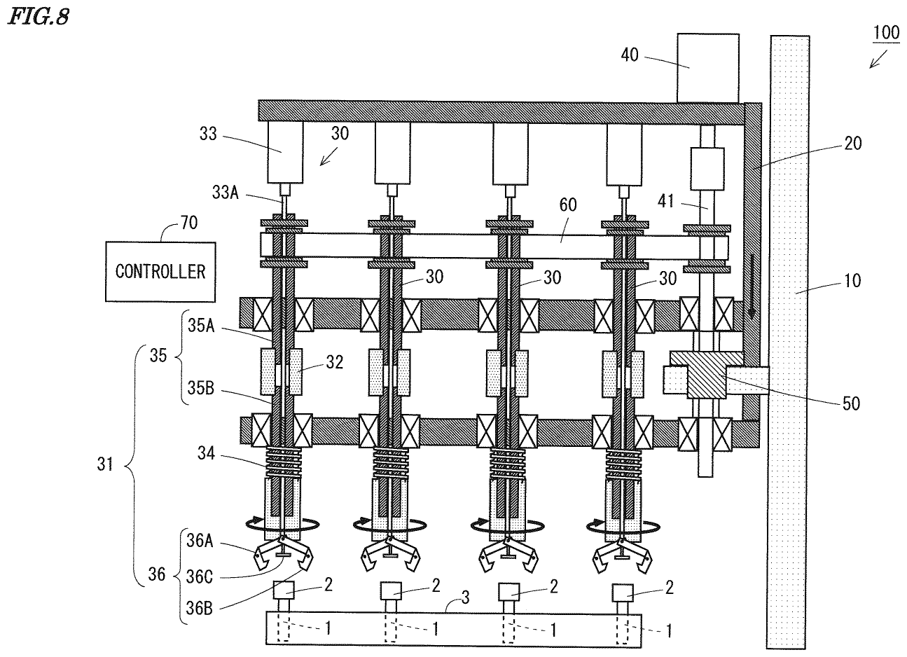

FIGS. 8 to 10 are diagrams for explaining the work for detaching the cap 2 performed by the cap attachment-detachment device 100. As shown in FIG. 8, when the cap 2 is detached, the grip portion 36 of the attachment-detachment portion 30 is located above the corresponding container 1 without gripping the cap 2 and with the grip claws 36A, 36B opened. In this state, the rotation driver 40 rotates in the forward direction. In this case, the holder 20 is moved downwardly with respect to the base portion 10 by the mover 50. Further, the rotation of the rotation driver 40 is transmitted to the attachment-detachment portion 30 by the transmitter 60. Therefore, the grip portion 36 of the attachment-detachment portion 30 is moved downwardly together with the movement of the holder 20 while rotating.

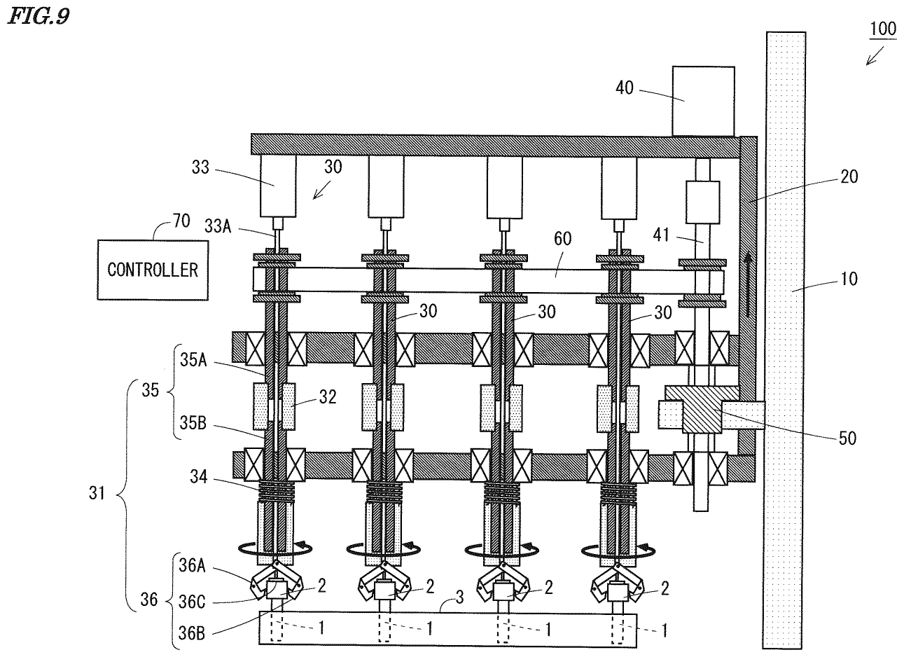

Thereafter, as shown in FIG. 9, the pressing member 36C of the grip portion 36 comes into contact with the top surface of the cap 2. In this case, the rotation of the pressing member 36C is stopped. Therefore, because not being rubbed by the pressing member 36C, the top surface of the cap 2 is prevented from being damaged. On the other hand, the grip claws 36A, 36B of the attachment-detachment portion 30 continue to rotate. When the attachment-detachment portion 30 is moved downwardly by a predetermined distance, the movement of the attachment-detachment portion 30 is stopped. At this time, the upper portion of the cap 2 is located between the grip claws 36A, 36B.

Here, the grip claws 36A, 36B are closed. Thus, an upward force is generated in the cap 2 by the grip claws 36A, 36B, and the top surface of the cap 2 is pressed downwardly by the pressing member 36C. In this case, because the pressing member 36C has a disc shape, the contact area between the pressing member 36C and the top surface of the cap 2 is are relatively large. Therefore, a pressing force to be applied from the pressing member 36C to the top surface of the cap 2 is relatively small. Thus, the top surface of the cap 2 is prevented from being damaged.

The top surface of the cap 2 is pressed by the pressing member 36C, so that the cap 2 is horizontally gripped in a stable state by the grip claws 36A, 36B. In this state, the rotation driver 40 rotates in the reverse direction. At this time, a torque applied to the cap 2 by the grip portion 36 is not restricted. Therefore, the cap 2 is efficiently loosened from the container 1. Further, the holder 20 is moved upwardly with respect to the base portion 10 by the mover 50. Thus, the cap 2 is detached from the container 1.

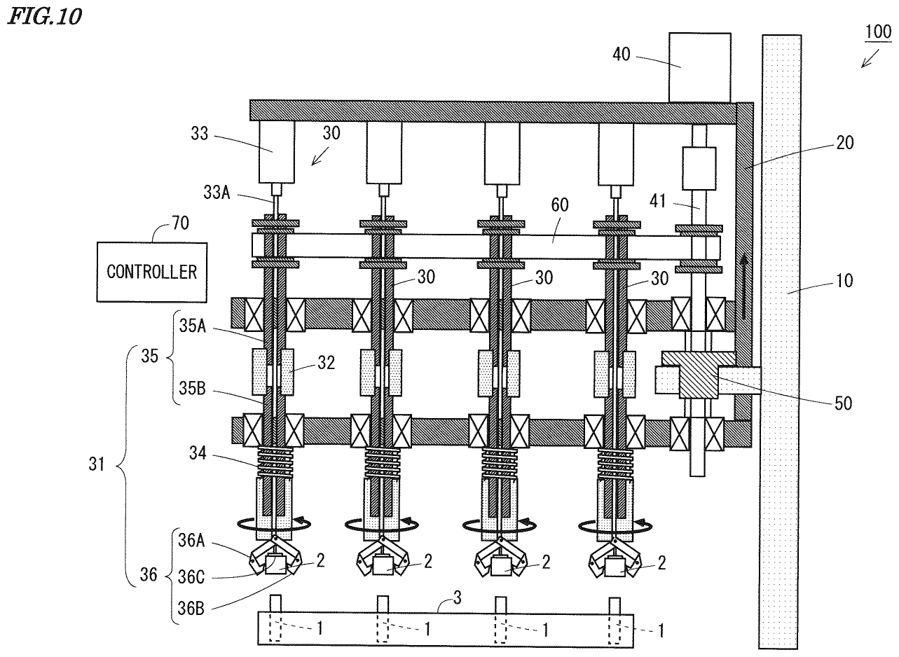

After the cap 2 is detached from the container 1, the rotation of the grip portion 36 in the reverse direction is continued as shown in FIG. 10. In this case, with the grip portion 36 gripping the cap 2, the holder 20 is moved upwardly with respect to the base portion 10 by the mover 50. Thus, the work for detaching the cap 2 ends.

### (5) Attachment-detachment Process

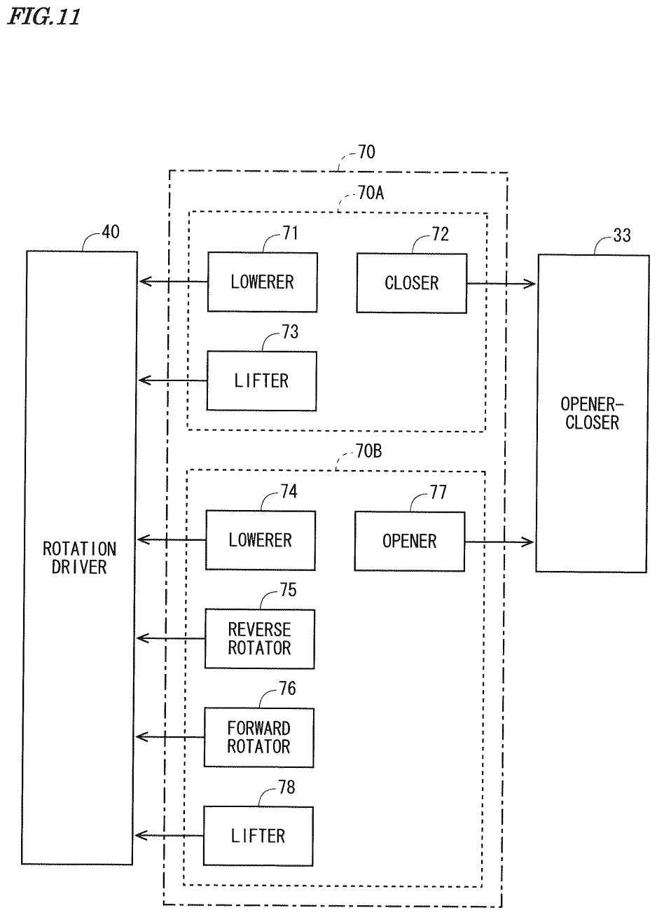

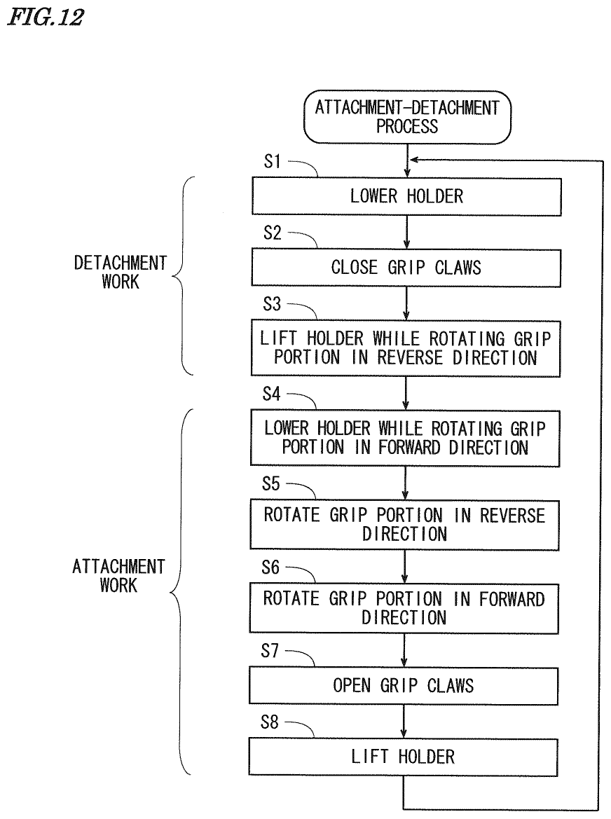

FIG. 11 is a diagram showing the configuration of the controller 70. FIG. 12 is a flowchart showing one example of the algorithm of an attachment-detachment process executed by the controller 70. As shown in FIG. 11, the controller 70 includes a detachment controller 70A and an attachment controller 70B as functions. The functions of the controller 70 are implemented by execution by the CPU of the controller 70 of an attachment-detachment program stored in the memory. Part or all of the functions of the controller 70 may be realized by hardware such as an electronic circuit.

The detachment controller 70A includes a lowerer 71, a closer 72 and a lifter 73 as functions, and controls the work for detaching the cap 2. The attachment controller 70B includes a lowerer 74, a reverse rotator 75, a forward rotator 76, an opener 77 and a lifter 78 as functions, and controls the work for attaching the cap 2. The attachment-detachment process will be described below with reference to the controller 70 of FIG. 11 and the flowchart of FIG. 12.

By controlling the rotation driver 40 and causing the rotation driver 40 to rotate in the forward direction, the lowerer 71 lowers the holder 20 by a predetermined distance (step S1). Thus, each grip portion 36 is lowered while rotating in the forward direction, and the pressing member 36C abuts against the cap 2 of the corresponding container 1. Next, by controlling the opening-closing portion 33, the closer 72 closes each of the grip claws 36A, 36B (step S2). Thus, each cap 2 is gripped by the corresponding grip claws 36A, 36B.

Subsequently, by controlling the rotation driver 40 and causing the rotation driver 40 to rotate in the reverse direction, the lowerer 71 lifts the holder 20 while rotating the grip portion 36 in the reverse direction (step S3). Thus, each cap 2 is detached from the corresponding 1. Each grip portion 36 returns to an initial position while gripping the detached cap 2.

Next, by controlling the rotation driver 40 and causing the rotation driver 40 to rotate in the forward direction, the lowerer 74 lowers the holder 20 by a predetermined distance (step S4). Thus, each grip portion 36 is lowered while gripping the cap 2 and rotating in the forward direction, and each cap 2 is fastened to the corresponding container 1. Subsequently, by controlling the rotation driver 40 and causing the rotation driver 40 to rotate in the reverse direction, the reverse rotator 75 rotates the grip portion 36 in the reverse direction by a predetermined angle (step S5). Thus, even in a case in which the cap 2 has been gripped by the grip portion 36 in an inclined posture, the posture of the cap 2 is corrected to be horizontal.

Thereafter, by controlling the rotation driver 40 and causing the rotation driver 40 to rotate in the forward direction, the forward rotator 76 rotates the grip portion 36 in the forward direction (step S6). Thus, each cap 2 is fastened to the corresponding container 1 while being in a horizontal posture. In this case, each cap 2 and the corresponding container 1 are properly fitted. As a result, each cap 2 can be attached to the corresponding container 1 so as to seal the container 1.

Next, by controlling the opening-closing portion 33, the opener 77 opens each of the grip claws 36A, 36B (step S7). Thus, gripping of the cap 2 by the grip portion 36 is released. Subsequently, by controlling the rotation driver 40 and causing the rotation driver 40 to rotate in the reverse direction, the lowerer 71 lifts the holder 20 (step S8). Thus, each grip portion 36 is lifted while rotating in the reverse direction and returns to the initial position. Thereafter, the process returns to the step S1.

The process of the above-mentioned steps S1 to S3 corresponds to the work for detaching the cap 2 performed by the detachment controller 70A, and the process of the steps S4 to S8 corresponds to the work for attaching the cap 2 performed by the attachment controller 70B. Between the step S3 and the next step S4, a sample, a solvent, an internal standard reagent or the like is added, dispensed, etc., to each container 1.

### (6) Effects

In the cap attachment-detachment device 100 according to the present embodiment, when the cap 2 is attached to the container 1, the cap 2 is griped by the operation portion 31 while the operation portion 31 abuts against the top surface of the cap 2 in which threads are formed. Further, the cap 2 gripped by the operation portion 31 abuts against the container 1. In this case, a pressing force applied from the cap 2 to the operation portion 31 is absorbed by the buffer portion 34. In this state, the work of the rotation driver 40 is controlled by the controller 70. Thus, the rotation of the rotation driver 40 is transmitted to the operation portion 31 through the transmitter 60, and the operation portion 31 is rotated.

Specifically, the controller 70 sequentially executes the first control, the second control and the third control. In the first control, the rotation driver 40 is rotated in the first direction, so that the cap 2 gripped by the operation portion 31 is fastened to the container 1. In the second control, the rotation driver 40 is rotated in the second direction opposite to the first direction, so that the cap 2 gripped by the operation portion 31 is loosened from the container 1. In the third control, the rotation driver 40 is rotated in the first direction, so that the cap 2 gripped by the operation portion 31 is fastened to the container 1.

With this configuration, in the second control, when the cap 2 is loosened from the container 1, a pressing force absorbed by the buffer portion 34 is applied to the top surface of the cap 2. Therefore, even in a case in which the cap 2 is gripped by the operation portion 31 while being inclined with respect to the container 1, the posture of the cap 2 is corrected to the posture not inclined with respect to the container 1. Therefore, in the third control, the cap 2 is fastened to the container 1 with the cap 2 and the container 1 properly fitted to each other. As a result, the cap 2 can more reliably seal the container 1.

The rotation angle of the cap 2 in the second control may be equal to or larger than the pitch angle of the cap 2, or an angle that is predetermined such that the cap 2 is not separated from the container 1. In this case, in the second control, a pressing force absorbed by the buffer portion 34 is properly and efficiently applied to the top surface of the cap 2. Thus, the posture of the cap 2 gripped by the operation portion 31 can be easily corrected.

When the cap 2 is attached to the container 1, the rotation driver 40 moves the operation portion 31 downwardly, thereby causing the cap 2 to abut against the container 1. In this case, it is possible to move the operation portion 31 using the single rotation driver 40 and cause the cap 2 to abut against the container 1, and rotate the cap 2 and attach the cap 2 to the container 1.

In the present example, the operation portion 31 is held by the holder 20. Further, in response to rotation of the rotation driver 40, the holder 20 is moved downwardly with respect to the base portion 10 by the mover 50. The mover 50 includes a linear motion ball screw member having the same pitch as the pitch of the cap 2. In this case, with the simple configuration, it is possible to rotate the cap 2 and attach the cap 2 to the container 1 while moving the operation portion 31 using the single rotation driver 40 and causing the cap 2 to abut against the container 1.

In the operation portion 31, the grip portion 36 is connected to the driven portion 35 and grips the cap 2. The driven portion 35 is rotated by transmission of the rotation of the rotation driver 40 by the transmitter 60. In this case, it is possible to easily rotate the operation portion 31 so as to attach the cap 2 to the container 1 in response to the rotation of the rotation driver 40.

In the grip portion 36, the pressing member 36C is configured to be abuttable against the top surface of the cap 2. The grip claws 36A, 36B are opposite to each other with a space below the pressing member 36C interposed therebetween. In this case, with the simple configuration, it is possible to grip the cap 2 while causing the operation portion 31 to abut against the top surface of the cap 2.

When the cap 2 is attached to the container 1, the restricting portion 32 restricts a torque to be applied to the cap 2 by the operation portion 31. With this configuration, in the first control or the third control, even in a case in which the cap 2 is rotated many times, excessive fastening is prevented. Further, the cap 2 is attached to the container 1 with a torque restricted by the restricting portion 32 while a pressing force to be applied from the cap 2 to the operation portion 31 is absorbed by the buffer portion 34. Therefore, it is possible to attach the cap 2 to the container 1 in a uniform fastening state.

In the present example, the driven member 35A and the driven member 35B of the driven portion 35 are connected by the restricting portion 32. The grip portion 36 is connected to the driven member 35B of the driven portion 35. When the cap 2 is attached to the container 1, in a case in which the rotation of the rotation driver 40 is transmitted to the driven member 35A by the transmitter 60, a torque transmitted from the driven member 35A to the driven member 35B is restricted by the restricting portion 32. In this case, in the first control or the third control, when the cap 2 is fastened to the container 1, a torque to be applied to the cap 2 by the operation portion 31 can be easily restricted.

### 2. Second Embodiment

### (1) Configuration of Cap Attachment-Detachment Device

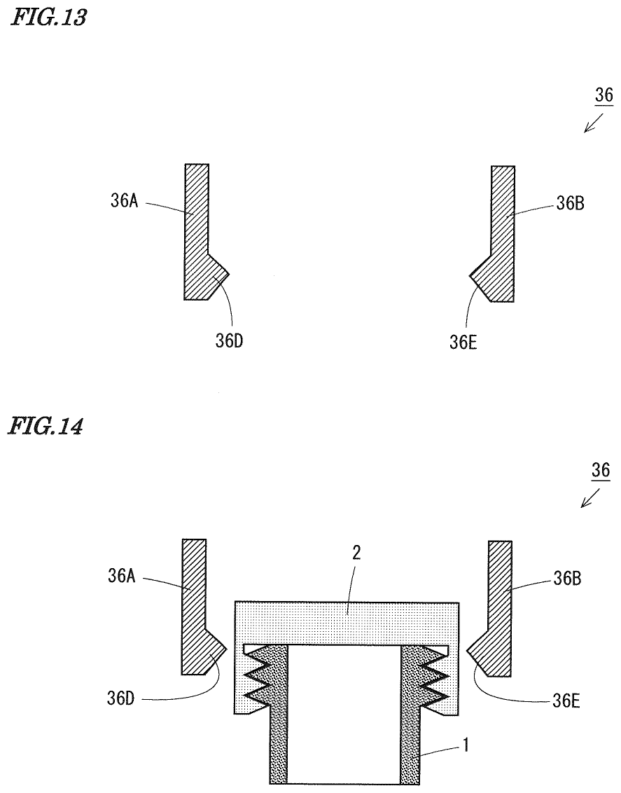

Differences of a cap attachment-detachment device 100 according to a second embodiment from the cap attachment-detachment device 100 according to the first embodiment will be described below. FIG. 13 is an enlarged view showing a portion of a grip portion 36 in the second embodiment. As shown in FIG. 13, in the present embodiment, protruding portions 36D, 36E that protrude inwardly and substantially horizontally are respectively formed in the lower end portions of grip claws 36A, 36B. The tip portions of the protruding portions 36D, 36E have a pointed shape and are opposite to each other.

FIGS. 14 to 16 are diagrams for explaining the work of the grip portion 36. The work for detaching the cap 2 in FIGS. 14 to 16 corresponds to the work for detaching the cap in FIGS. 8 to 10. As shown in FIG. 14, when the cap 2 is detached, the grip claws 36A, 36B of the grip portion 36 are opposite to each other with the cap 2 interposed therebetween. In this state, the grip claws 36A, 36B are closed, so that the protruding portions 36D, 36E of the grip claws 36A, 36B are pressed against the outer peripheral surface of the cap 2 as shown in FIG. 15.

Here, the cap 2 is formed of a soft material such as resin. Therefore, the protruding portions 36D, 36E are pressed, so that the protruding portions 36D, 36E dig into the outer peripheral surface of the cap 2. Dents 2a are formed at portions of the cap 2 into which the protruding portions 36D, 36E dig. It is possible to detach the cap 2 from the container 1 by rotating the grip portion 36 in a predetermined direction (the above-mentioned reverse direction) in this state.

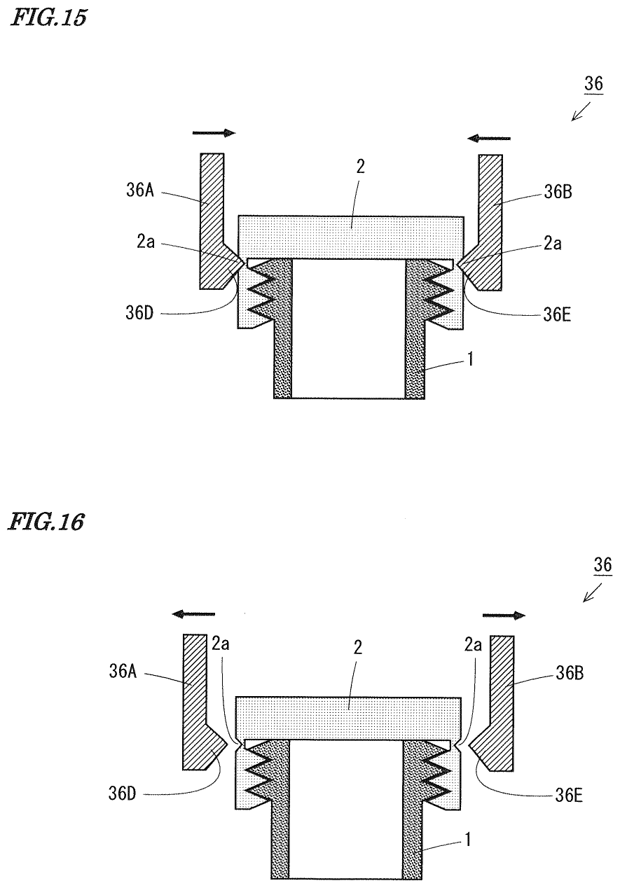

Alternatively, before the grip portion 36 is rotated in the state of FIG. 15, the grip claws 36A, 36B may be opened as shown in FIG. 16. Even in this case, the dents 2a formed on the outer peripheral surface of the cap 2 remain. As such, the grip claws 36A, 36B may be closed again. In this case, the protruding portions 36D, 36E dig into the outer peripheral surface of the cap 2 again, so that the dents 2a formed on the outer peripheral surface of the cap 2 are deepened. In this state, it is possible to more reliably detach the cap 2 from the container 1 by rotating the grip portion 36 in the predetermined direction.

### (2) Attachment-Detachment Process

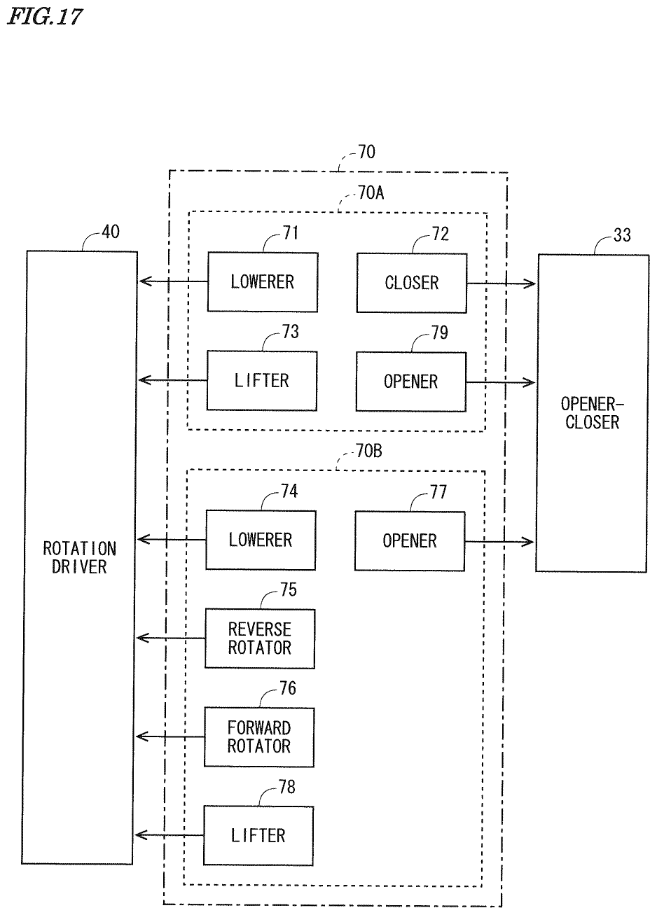

FIG. 17 is a diagram showing the configuration of a controller 70 in the second embodiment. As shown in FIG. 17, a detachment controller 70A of the controller 70 in the present embodiment further includes an opener 79 as a function. During the work for detaching the cap 2, the opener 79 controls an opening-closing portion 33 such that the grip claws 36A, 36B are opened.

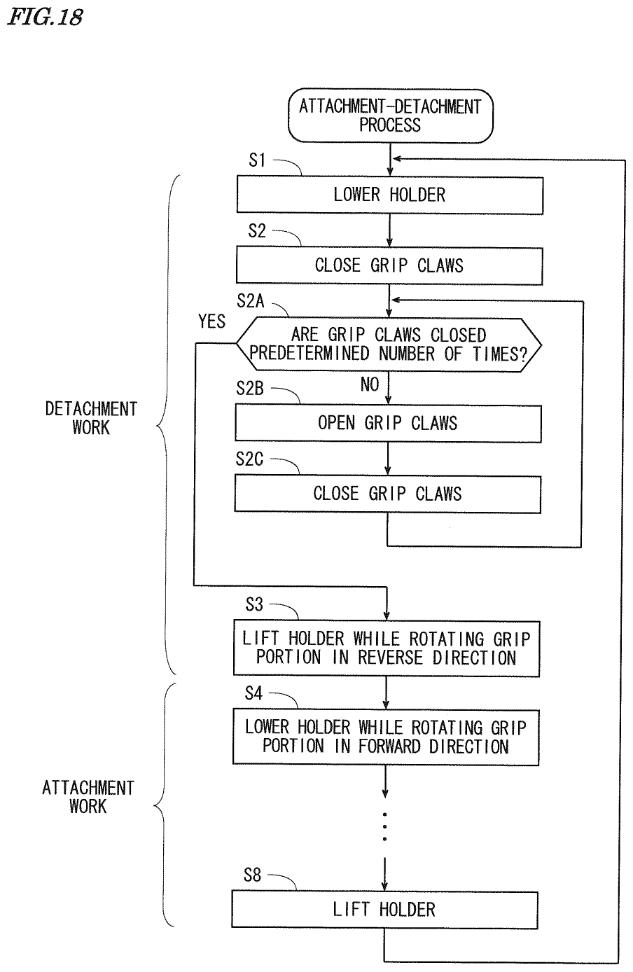

FIG. 18 is a flowchart showing one example of the algorithm of an attachment-detachment process in the second embodiment. As shown in FIG. 18, the detachment work of the attachment-detachment process in the present embodiment further includes the steps S2A to S2C between the step S2 and the step S3.

Specifically, in the step S2, the grip claws 36A, 36B are closed. In this case, the pointed tip portions of the grip claws 36A, 36B abut against the outer peripheral surface of the cap 2. Therefore, the dents 2a are formed on the outer peripheral surface of the cap 2 by the protruding portions 36D, 36E of the grip claws 36A, 36B. Thus, the cap 2 is gripped by the grip claws 36A, 36B with the protruding portions 36D, 36E dug into the outer peripheral surface of the cap 2.

Next, the closer 72 determines whether the grip claws 36A, 36B are closed a predetermined number of times (step S2A). The number of times the grip claws 36A, 36B are closed may be determined in advance. Alternatively, the number of times the grip claws 36A, 36B are closed may be set to any number. In this case, a user can set a desired number of times the grip claws 36A, 36B can be closed in a predetermined waiting period of time in a pre-process.

In a case in which the grip claws 36A, 36B are not closed the predetermined number of times, the opener 79 opens the grip claws 36A, 36B by controlling the opening-closing portion 33 (step S2B). In this case, the grip claws 36A, 36B are separated from the cap 2.

Subsequently, the closer 72 closes the grip claws 36A, 36B by controlling the opening-closing portion 33 (step S2C). In this case, the pointed tip portions of the grip claws 36A, 36B abut against the outer peripheral surface of the cap 2 again, so that the dents S2 formed in the outer peripheral surface of the cap 2 in the step 2 are deepened. Thus, the cap 2 is gripped by the grip claws 36A, 36B with the protruding portions 36D, 36E dug into the outer peripheral surface of the cap 2 more deeply.

After the step S2C is executed, the process returns to the step S2A. The steps S2A, S2B and S2C are repeated until the grip claws 36A, 36B are closed the predetermined number of times. In a case in which the grip claws 36A, 36B are closed the predetermined number of times in the step S2A, the process proceeds to the step S3. Thus, the step S3 and the subsequent steps in the attachment-detachment process of FIG. 12 are executed.

The number of times the grip claws 36A, 36B are closed in the step S2A may be one in a case in which the cap 2 can be reliably detached from the container 1. In this case, the steps S2B and S2C are not executed. Therefore, the detachment controller 70A does not have to include the opener 79.

### (3) Effects

In the cap attachment-detachment device 100 according to the present embodiment, the tip of the grip portion 36 of an operation portion 31 has a pointed shape. Therefore, when the cap 2 is detached from the container 1, the tip of the grip portion 36 abuts against the cap 2, thereby digging into the cap 2. In this case, the pseudo static frictional force between the grip portion 36 and the cap 2 increases. This prevents idling between the grip portion 36 and the cap 2 when the operation portion 31 rotates. As a result, the cap 2 can be reliably detached from the container 1.

Further, after the tip of the grip portion 36 abuts against the cap 2, the control for separating the tip of the grip portion 36 from the cap 2 and the control for causing the tip of the grip portion 36 to abut against the cap 2 again may be executed once or more. In this case, the tip of the grip portion 36 digs deeper into the cap 2 each time the tip of the grip portion 36 abuts against the cap 2. Therefore, the pseudo static frictional force between the grip portion 36 and the cap 2 is further increased. Thus, the cap 2 can be more reliably detached from the container 1.

### (4) Reference Example

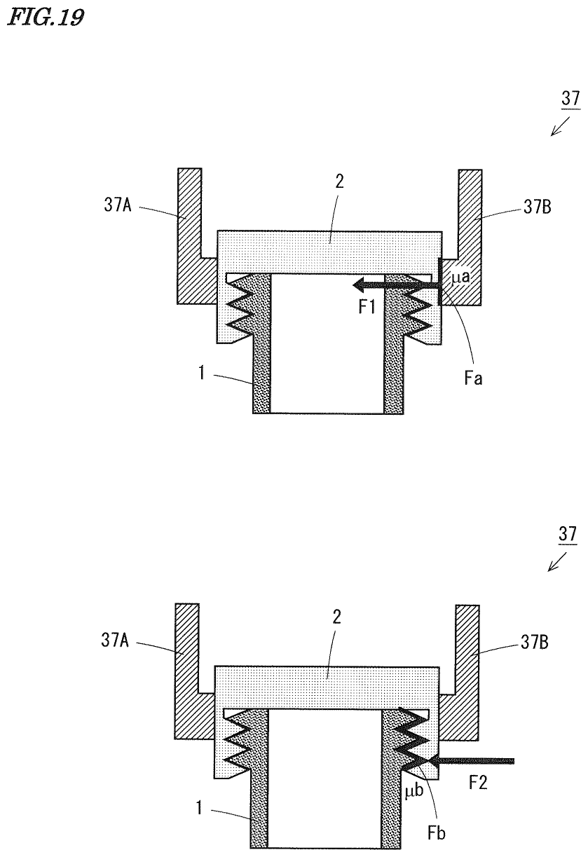

FIG. 19 is a diagram for explaining the work for detaching the cap 2 in a reference example. As shown in FIG. 19, in the reference example, the work for detaching the cap 2 is performed using a grip portion 37 similar to the “robot hand 12” described in Patent Document 1. Specifically, the grip portion 37 includes grip claws 37A, 37B. In each of the grip claws 37A, 37B, a protruding portion having a pointed tip portion is not formed.

In the work for detaching the cap 2, the grip claws 37A, 37B are closed with the grip claws 37A, 37B being opposite to each other with the cap 2 interposed therebetween, and thus the grip claws 37A, 37B come into contact with the outer peripheral surface of the cap 2. In this case, as shown in the upper field of FIG. 19, a force F₁ is applied to the outer peripheral surface of the cap 2. Here, when the grip portion 37 rotates to detach the cap 2, a static frictional force Fₐ is generated between the grip claws 37A, 37B and the cap 2. Letting the coefficient of static friction between the grip claws 37A, 37B and the cap 2 be μₐ, the static frictional force Fₐ is F1·μₐ.

On the other hand, as shown in the lower field of FIG. 19, when the force F₁ is applied to the outer peripheral surface of the cap 2, a force F₂ is applied to the outer peripheral surface of the container 1 by the inner peripheral surface of the cap 2. Here, when the cap 2 rotates with respect to the container 1, a static frictional force F_{b} is generated between the container 1 and the cap 2. Letting the coefficient of static friction between the container 1 and the cap 2 be μ_{b}, the static frictional force F_{b} is F₂·μ_{b}.

In a case in which the static frictional force Fₐ is larger than the static frictional force F_{b}, the cap 2 rotates together with the grip portion 37 since the cap 2 and the grip claws 37A, 37B continue to be in contact with each other. Thus, the cap 2 can be detached from the container 1. In a case in which the static frictional force Fₐ is smaller than the static frictional force F_{b}, the cap 2 is kept stationary together with the container 1 since the cap 2 and the container 1 continue to be in contact with each other. In this case, the grip portion 37 idles, and the cap 2 cannot be detached from the container 1. That is, in order to detach the cap 2 from the container 1, the following formula (1) needs to be satisfied.

$${F}_{1} \cdot {μ}_{a} > {F}_{2} \cdot {μ}_{b} \qquad ( 1 )$$

However, the coefficient μ_{b} of static friction is a value defined based on the materials of the container 1 and the cap 2, and cannot be arbitrarily changed. Further, the force F₂ is a value that changes in proportion to the force F₁, and cannot be changed independently of the force F₁. Therefore, when the force F₁ is increased, the force F₂ is also increased at the same rate. Thus, it is difficult to reliably satisfy the formula (1).

In contrast, in the present embodiment, the protruding portions 36D, 36E having the pointed shape dig into the outer peripheral surface of the cap 2, so that the grip claws 36A, 36B and the cap 2 are strongly coupled. Therefore, the coefficient μa of static friction between the grip claws 36A, 36B and the cap 2 increases in a pseudo manner. Thus, the formula (1) can be easily satisfied. As a result, the cap 2 can be reliably detached from the container 1.

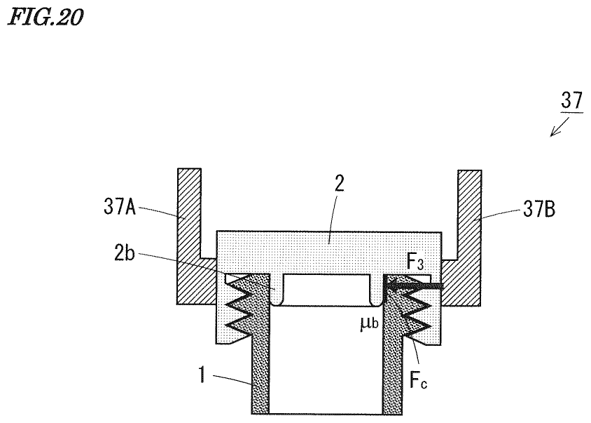

Further, the cap 2 may have a lip seal type. FIG. 20 is a diagram for explaining the work for detaching a cap 2 having the lip seal type. As shown in FIG. 20, the cap 2 having the lip seal type includes an annular lip portion 2b which protrudes downwardly from the bottom surface. With the cap 2 attached to the container 1, the outer peripheral surface of the lip portion 2b is in close contact with the inner peripheral surface of the container 1.

Also in the work for detaching the cap 2 having the lip seal type, the grip claws 37A, 37B are closed while being opposite to each other with the cap 2 interposed therebetween. Here, when the force F₁ is applied to the outer peripheral surface of the cap 2, a force F₃ is further applied to the outer peripheral surface of the lip portion 2b of the cap 2 by the inner peripheral surface of the container 1. In this case, when the cap 2 rotates with respect to the container 1, a static frictional force F_{c} is further generated between the container 1 and the lip portion 2b of the cap 2. The static frictional force F_{c} is F₃·μ_{b}.

In a case in which the static frictional force Fₐ is larger than the sum of the static frictional forces F_{b} and F_{c}, the cap 2 can be detached from the container 1. On the other hand, in a case in which the static frictional force Fₐ is smaller than the sum of the static frictional forces F_{b} and F_{c}, the grip portion 37 idles, and the cap 2 cannot be detached from the container 1. Therefore, in order to detach the cap 2 from the container 1, the following formula (2) needs to be satisfied.

$${F}_{1} \cdot {μ}_{a} > {F}_{2} \cdot {μ}_{b} + {F}_{3} \cdot {μ}_{b} \qquad ( 2 )$$

The right side of the formula (2) is larger than the right side of the formula (1) by the second term. Further, similarly to the force F₂, the force F₃ is a value that changes in proportion to the force F₁, and cannot be changed independently of the force F₁. Therefore, when the force F₁ is increased, the force F₃ is also increased at the same rate. Thus, it is difficult to reliably satisfy the formula (2). That is, with the lip seal type, although the sealing property between the container 1 and the cap 2 is improved, it is more difficult to detach the cap 2 from the container 1.

Even in such a case, in the present embodiment, the coefficient μₐ of static friction between the grip claws 36A, 36B and the cap 2 increases in a pseudo manner as described above. Thus, the formula (2) can be easily satisfied. As a result, even with the lip seal type, the cap 2 can be reliably detached from the container 1.

### 3. Third Embodiment

### (1) Attachment-Detachment Process

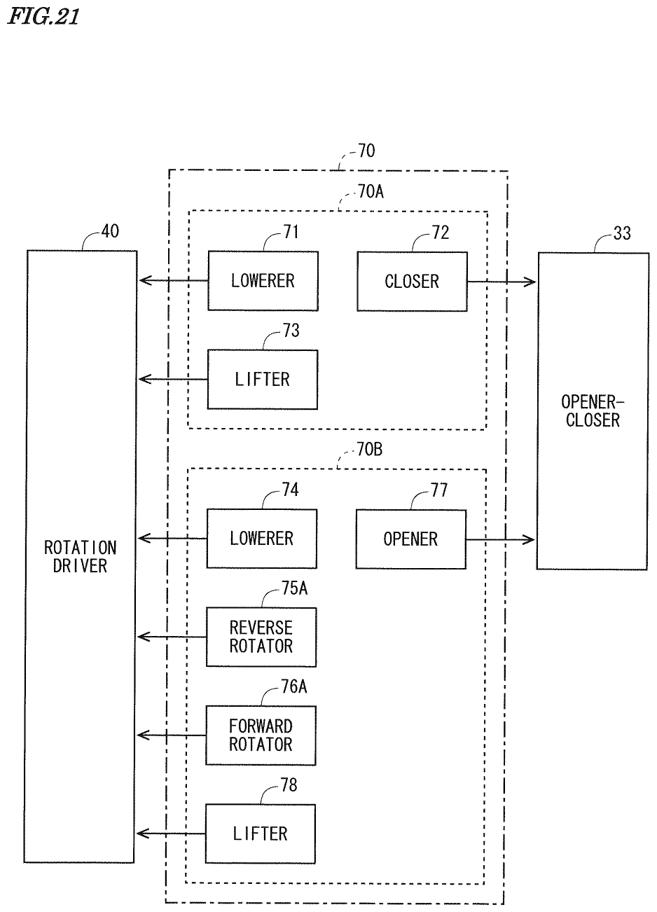

Differences of a cap attachment-detachment device 100 according to a third embodiment from the cap attachment-detachment device 100 according to the first embodiment will be described below. FIG. 21 is a diagram showing the configuration of a controller 70 in the third embodiment. As shown in FIG. 21, an attachment controller 70B of the controller 70 in the present embodiment includes a reverse rotator 75A and a forward rotator 76A instead of the reverse rotator 75 and the forward rotator 76.

The reverse rotator 75A controls a rotation driver 40 such that a grip portion 36 rotates in a reverse direction during the work for detaching a cap 2. A rotation angle by which the rotation driver 40 is rotated by the reverse rotator 75A is larger than a rotation angle by which the rotation driver 40 is rotated by the reverse rotator 75. The forward rotator 76A controls the rotation driver 40 such that the grip portion 36 rotates in a forward direction during the work for detaching the cap 2. A rotation angle by which the rotation driver 40 is rotated by the forward rotator 76A is larger than a rotation angle by which the rotation driver 40 is rotated by the forward rotator 76.

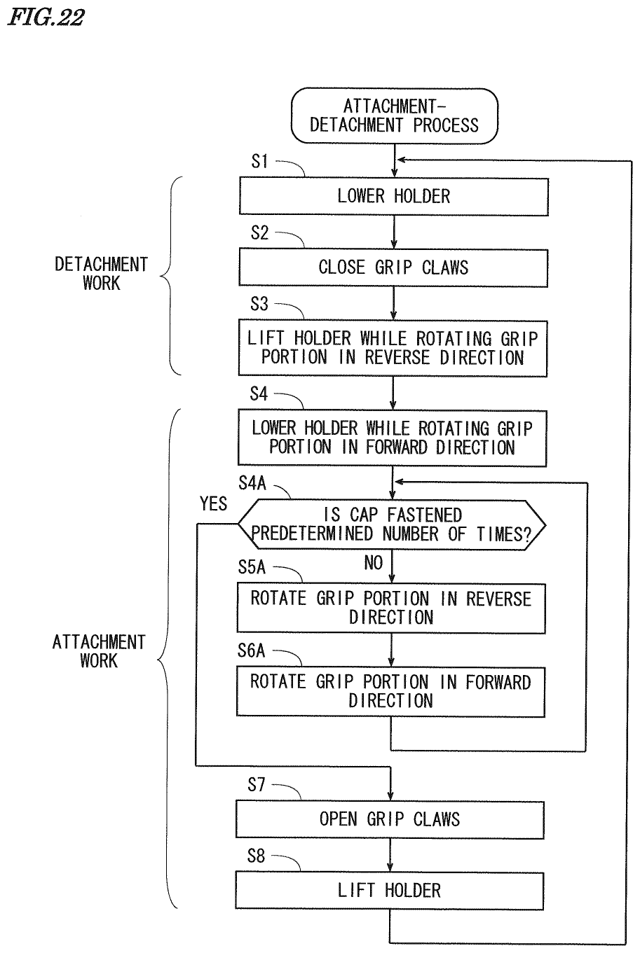

FIG. 22 is a flowchart showing one example of the algorithm of an attachment-detachment process in the third embodiment. As shown in FIG. 22, the attachment-detachment process in the present embodiment further includes the step S4A after the step S4. Further, the attachment-detachment process in the present embodiment includes the steps S5A and S5B instead of the steps S5 and S6. In this attachment-detachment process, the grip portion 36 does not have to include the pressing member 36C.

Specifically, in the step S4, each grip portion 36 rotates in the forward direction and moves downwardly while gripping the cap 2. Thus, each cap 2 is fastened to the corresponding container 1.

Next, the reverse rotator 75A determines whether the cap 2 is fastened to the container 1 a predetermined number of times (step S4A). The number of times the cap 2 is fastened may be predetermined. The number of times the cap 2 is fastened may be set to any number. In this case, a user can set a desired number of times the grip claws 36A, 36B can be fastened in a predetermined waiting period of time in a pre-process.

In a case in which the cap 2 is not fastened the predetermined number of times, the reverse rotator 75A rotates the grip portion 36 in the reverse direction by a predetermined angle by controlling the rotation driver 40 (step S5A). Thus, the cap 2 is detached from the container 1. In the step S5A, the grip portion 36 may be sufficiently rotated in the reverse direction until the cap 2 is separated from the container 1. Subsequently, the forward rotator 76A rotates the grip portion 36 in the forward direction by a predetermined angle by controlling the rotation driver 40 (step S6A). In this case, each cap 2 is fastened to the container 1 again.

After the step S6A is executed, the process returns to the step S4A. The steps S4A, S5A and S6A are repeated until the cap 2 is fastened the predetermined number of times. The steps S5A and S6A correspond to the adjusting work for adjusting the cap 2 to the container 1. In a case in which the cap 2 is fastened the predetermined number of times in the step S4A, the process proceeds to the step S7. Thus, the step S7 and the subsequent steps are executed.

### (2) Effects

In the cap attachment-detachment device 100 according to the present embodiment, when the cap 2 is attached to the container 1, the cap 2 abuts against the container 1 while being gripped by the operation portion 31. In this state, the rotation driver 40 is rotated in the first direction. Thus, the rotation of the rotation driver 40 is transmitted to the operation portion 31 through the transmitter 60, and the operation portion 31 is rotated. Thus, the cap 2 gripped by the operation portion 31 is fastened to the container 1.

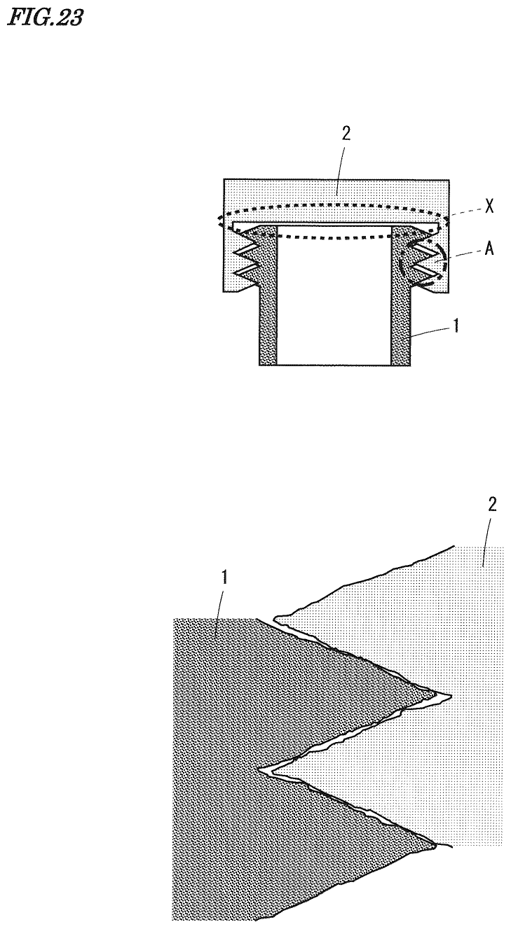

FIG. 23 is a diagram showing the container 1 and the cap 2 when the cap 2 is fastened to the container 1. In the upper field of FIG. 23, the cross sectional view of the container 1 and the cap 2 is shown, and in the lower field of FIG. 23, an enlarged view of a portion A of the container 1 and the cap 2 is shown. In a case in which the forming accuracy of the container 1 and the cap 2 is low, the container 1 and the cap 2 are not sufficiently adjusted to each other. Therefore, as shown in the lower field of FIG. 23, the container 1 and the cap 2 are not properly fitted to each other, and the threads of the container 1 and the threads of the cap 2 may not be in close contact with each other. In this case, as shown in a portion X in the upper field of FIG. 23, a gap is formed between the container 1 and the cap 2.

As such, after the cap 2 is fastened to the container 1, the adjusting work for adjusting the cap 2 to the container 1 is performed. In the adjusting work, after the cap 2 is fastened to the container 1, the control in which the operation portion 31 is rotated in the second direction and the cap 2 is detached from the container 1, and the control in which the operation portion 31 is rotated in the first direction and the cap 2 is fastened again to the container 1, are executed once or more.

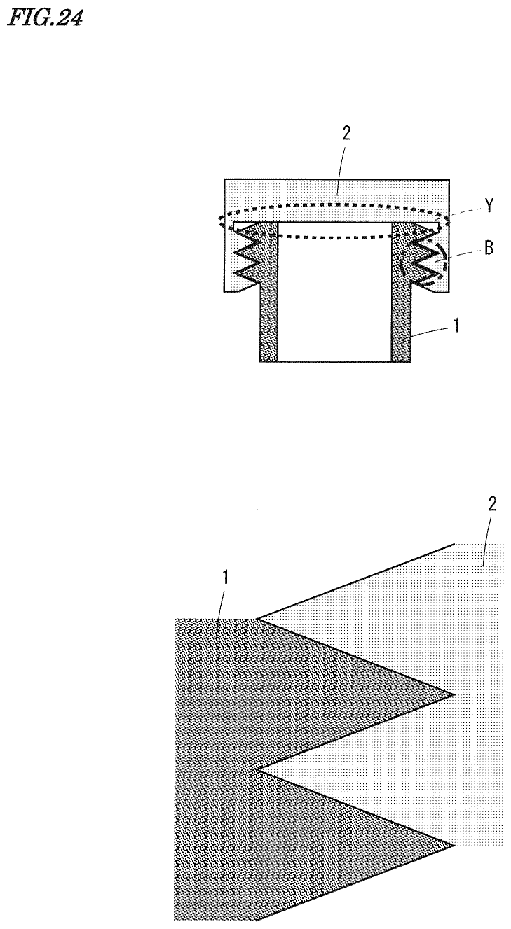

FIG. 24 is a diagram showing the container 1 and the cap 2 when the adjusting work is performed. In the upper field of FIG. 24, the cross sectional view of the container 1 and the cap 2 is shown, and in the lower field of FIG. 24, an enlarged view of a portion B of the container 1 and the cap 2 is shown. The adjusting work is performed, so that the container 1 and the cap 2 are adjusted to each other each time the cap 2 is fastened to the container 1. Thus, as shown in the lower field of FIG. 24, the cap 2 and the container 1 are fastened more tightly, and the threads of the container 1 and the threads of the cap 2 are brought into close contact with each other. As a result, as shown in a portion Y in the upper field of FIG. 24, the cap 2 can reliably seal the container 1 without formation of a gap.

### 4. Other Embodiments

(1) While the rotation driver 40 is provided as a single actuator that rotates the attachment-detachment portion 30 while lifting and lowering the attachment-detachment portion 30 in the above-mentioned embodiment, the embodiment is not limited to this. An actuator for lifting and lowering the attachment-detachment portion 30 and an actuator for rotating the attachment-detachment portion 30 may be separately provided.
(2) While the cap attachment-detachment device 100 includes the plurality of attachment-detachment portions 30 in the above-mentioned embodiment, the embodiment is not limited to this. The cap attachment-detachment device 100 may include a single attachment-detachment portion 30.
(3) While the protruding portions 36D, 36E are respectively formed in the grip claws 36A, 36B of the grip portion 36 in the second embodiment, the embodiment is not limited to this. A protruding portion may be formed in one of the grip claws 36A, 36B, and a protruding portion does not have to be formed in the other one of the grip claws 36A, 36B.
(4) While the attachment work similar to that of the first embodiment is performed as the attachment work in the attachment-detachment process in the second embodiment, the embodiment is not limited to this. In a case in which the cap 2 can be reliably attached to the container 1, the steps S5 and S6 do not have to be executed during the attachment work in the attachment-detachment process. In this case, the grip portion 36 does not have to include the pressing member 36C.
(5) While the detachment work similar to that of the first embodiment is performed as the detachment work in the attachment-detachment process in the third embodiment, the embodiment is not limited to this. The detachment work similar to that of the second embodiment may be performed as the detachment work in the attachment-detachment process. In this case, the protruding portions 36D, 36E are respectively formed in the grip claws 36A, 36B of the grip portion 36. Further, the detachment controller 70A of the controller 70 further includes an opener 79.

### 5. Aspects

It is understood by those skilled in the art that the plurality of above-mentioned illustrative embodiments are specific examples of the below-mentioned aspects.
(Item 1) A cap attachment-detachment device according to one aspect may include a rotation driver that is rotatable in a first direction and a second direction that are opposite to each other, an operation portion that, when a cap is attached to a container, grips the cap while abutting against a top surface of the cap in which threads are formed, and causes the gripped cap to abut against the container, a transmitter that rotates the operation portion by transmitting rotation of the rotation driver to the operation portion, a buffer portion that, when the cap is attached to the container, absorbs a pressing force applied from the cap to the operation portion, and a controller that controls work of the rotation driver, wherein the controller, when the cap is attached to the container, may sequentially execute first control in which the cap gripped by the operation portion is fastened to the container by rotation of the rotation driver in the first direction, second control in which the cap gripped by the operation portion is loosened from the container by rotation of the rotation driver in the second direction, and third control in which the cap gripped by the operation portion is fastened to the container by rotation of the rotation driver in the first direction.

In this cap attachment-detachment device, when the cap is attached to the container, the cap is griped by the operation portion while the operation portion abuts against the top surface of the cap in which threads are formed. Further, the cap gripped by the operation portion abuts against the container. In this case, a pressing force applied from the cap to the operation portion is absorbed by the buffer portion. In this state, the work of the rotation driver is controlled by the controller. Thus, the rotation of the rotation driver is transmitted to the operation portion through the transmitter, and the operation portion is rotated.

Specifically, the controller sequentially executes the first control, the second control and the third control. In the first control, the rotation driver is rotated in the first direction, so that the cap gripped by the operation portion is fastened to the container. In the second control, the rotation driver is rotated in the second direction opposite to the first direction, so that the cap gripped by the operation portion is loosened from the container. In the third control, the rotation driver is rotated in the first direction, so that the cap gripped by the operation portion is fastened to the container.

With this configuration, in the second control, when the cap is loosened from the container, a pressing force absorbed by the buffer portion is applied to the top surface of the cap. Therefore, even in a case in which the cap is gripped by the operation portion while being inclined with respect to the container, the posture of the cap is corrected to the posture not inclined with respect to the container. Therefore, in the third control, the cap is fastened to the container with the cap and the container properly fitted to each other. As a result, the cap can reliably seal the container.
(Item 2) The cap attachment-detachment device according to item 1, wherein the controller may cause the cap to rotate by an angle equal to or larger than a pitch angle of the cap in the second control.

In this case, in the second control, a pressing force absorbed by the buffer portion is properly applied to the top surface of the cap. Thus, the posture of the cap gripped by the operation portion can be easily corrected.
(Item 3) The cap attachment-detachment device according to item 1 or 2, wherein in the second control, the controller may cause the cap to rotate by an angle that is defined such that the cap is not separated from the container.

In this case, in the second control, the pressing force absorbed by the buffer portion is efficiently applied to the top surface of the cap. Thus, the posture of the cap gripped by the operation portion can be easily corrected.
(Item 4) The cap attachment-detachment device according to item 1 or 2, wherein when the cap is attached to the container, the rotation driver may cause the cap to abut against the container by moving the operation portion.

In this case, it is possible to move the operation portion using the single rotation driver and cause the cap to abut against the container, and it is possible to rotate the cap to attach the cap to the container.
(Item 5) The cap attachment-detachment device according to item 4, may further include a base portion, a holder that holds the operation portion, and a mover that moves the holder in one direction with respect to the base portion in response to rotation of the rotation driver.

In this case, with the simple configuration, it is possible to rotate the cap to attach the cap to the container while moving the operation portion using the single rotation driver and causing the cap to abut against the container.
(Item 6) The cap attachment-detachment device according to item 5, wherein the mover may include a linear-motion ball screw member having a same pitch as a pitch of the cap.

In this case, with the simpler configuration, it is possible to rotate the cap to attach the cap to the container while moving the operation portion using the single rotation driver and causing the cap to abut against the container.
(Item 7) The cap attachment-detachment device according to item 1 or 2, wherein the operation portion may include a pressing member configured to be abuttable against the top surface of the cap, and a first grip claw and a second grip claw that are opposite to each other with a space below the pressing member interposed between the first grip claw and the second grip claw.

In this case, with the simple configuration, it is possible to grip the cap while causing the operation portion to abut against the top surface of the cap.
(Item 8) The cap attachment-detachment device according to item 1 or 2, may further include a restricting portion that, when the cap is attached to the container, restricts a torque to be applied to the cap by the operation portion.

With this configuration, in the first control or the third control, even in a case in which the cap is rotated many times, excessive fastening is prevented. Further, the cap is attached to the container with a torque restricted by the restricting portion while a pressing force applied from the cap to the operation portion is absorbed by the buffer portion. Therefore, it is possible to attach the cap to the container in a uniform fastening state.
(Item 9) The cap attachment-detachment device according to item 8, wherein the operation portion may include a grip portion that grips the cap, and a driven portion to which the grip portion is connected and which rotates when rotation of the rotation driver is transmitted by the transmitter.

In this case, it is possible to easily rotate the operation portion to attach the cap to the container in response to the rotation of the rotation driver.
(Item 10) The cap attachment-detachment device according to item 9, wherein the driven portion may include a first driven member to which rotation of the rotation driver is transmitted by the transmitter, and a second driven member to which the grip portion is connected, and the restricting portion, when the cap is attached to the container, connects the first driven member and the second driven member to each other such that a torque to be transmitted from the first driven member to the second driven member is restricted.

In this case, in the first control or the third control, when the cap is fastened to the container, it is possible to easily restrict a torque to be applied to the cap by the operation portion.
(Item 11) The cap attachment-detachment device according to item 1 or 2, wherein a plurality of the operation portions and a plurality of the buffer portions may be provided to correspond to a plurality of the caps, and the transmitter may rotate each operation portion by transmitting rotation of the rotation driver to the plurality of the operation portions.

In this case, the plurality of caps can be attached to a plurality of containers at the same time. Further, even in a case in which the plurality of containers have dimensional variations due to individual differences, the caps are respectively fastened to the corresponding containers with the caps and the containers properly fitted to each other. Thus, each cap can reliably seal the corresponding container.
(Item 12) A pre-processing device according to another aspect may include the cap attachment-detachment device according to item 1 or 2 that attaches a cap to and detaches the cap from a container, and a pre-processor that executes a pre-process on a sample contained in the container.

In this pre-processing device, the cap can be attached properly by the above-mentioned cap attachment-detachment device. Thus, the throughput can be improved. Further, it can save human labor.
(Item 13) A cap attachment method according to yet another aspect that is executed by a cap attachment-detachment device, may include gripping a cap using an operation portion while causing the operation portion to abut against a top surface of the cap in which threads are formed, absorbing a pressing force to be applied from the cap to the operation portion using a buffer portion while causing the cap gripped by the operation portion against a container, fastening the cap gripped by the operation portion to the container by rotating a rotation driver in a first direction, applying a pressing force absorbed by the buffer portion to the top surface of the cap while loosening the cap gripped by the operation portion from the container by rotating the rotation driver in a second direction opposite to the first direction after the cap is fastened to the container, and fastening the cap gripped by the operation portion to the container by rotating the rotation driver in the first direction after the cap is loosened from the container.

With this cap attachment method, when the cap is loosened from the container, a pressing force absorbed by the buffer portion is applied to the top surface of the cap. Therefore, even in a case in which the cap is gripped by the operation portion while being inclined with respect to the container, the posture of the cap is corrected to the posture not inclined with respect to the container. Therefore, after that, the cap is fastened to the container with the cap and the container properly fitted to each other. As a result, the cap can reliably seal the container.
(Item 14) A cap attachment-detachment device according to yet another aspect may include a rotation driver that is rotatable in a predetermined direction, an operation portion including a grip portion having a pointed tip, a transmitter that rotates the operation portion by transmitting rotation of the rotation driver to the operation portion, and a controller that, when a cap is detached from a container, controls work of the operation portion such that the tip of the grip portion abuts against the cap in which threads are formed.

In this cap attachment-detachment device, the tip of the grip portion of the operation portion has a pointed shape. Therefore, when the cap is detached from the container, the pointed tip of the grip portion abuts against the cap, thereby digging into the cap. In this case, the pseudo static frictional force between the grip portion and the cap increases. Thus, when the operation portion rotates, it prevents idling between the grip portion and the cap. As a result, the cap can be reliably detached from the container.
(Item 15) The cap attachment-detachment device according to item 14, wherein the controller, after the tip of the grip portion abuts against the cap, may further control work of the operation portion such that control in which the tip of the grip portion is separated from the cap and control in which the tip of the grip portion abuts against the cap again are executed once or more.

In this case, the tip of the grip portion digs deeper into the cap each time the tip of the grip portion abuts against the cap. Therefore, the pseudo static frictional force between the grip portion and the cap is further increased. Thus, the cap can be more reliably detached from the container.
(Item 16) A cap attachment-detachment device according to yet another aspect may include a rotation driver that is rotatable in a first direction and a second direction that are opposite to each other, an operation portion that, when a cap is attached to a container, grips the cap in which threads are formed and causes the gripped cap to abut against the container, a transmitter that rotates the operation portion by transmitting rotation of the rotation driver to the operation portion, and a controller that, when the cap is attached to the container, controls work of the rotation driver such that the operation portion rotates in the first direction and the cap is fastened to the container, wherein the controller may further control work of the operation portion such that, after the cap is fastened to the container, control in which the operation portion rotates in the second direction and the cap is detached from the container and control in which the operation portion rotates in the first direction and the cap is fastened to the container again, are executed once or more.

In this cap attachment-detachment device, when the cap is attached to the container, the container and the cap are adjusted to each other each time the cap is fastened to the container. Therefore, the cap and the container are fastened more tightly. Thus, the cap can reliably close the container.
(Item 17) A cap attachment method according to yet another aspect executed by a cap attachment-detachment device may include gripping a cap in which threads are formed and causing the cap to abut against a container, fastening the cap gripped by the operation portion to the container by rotating a rotation driver in a first direction, and performing adjusting work for adjusting the cap to the container, wherein the adjusting work may include, after the cap is fastened to the container, rotating the operation portion in a second direction opposite to the first direction to detach the cap from the container and rotating the operation portion in the first direction to fasten the cap to the container again, once or more.

With this cap attachment method, the container and the cap are adjusted to each other each time the cap is fastened to the container. Therefore, the cap and the container are fastened more tightly. Thus, the cap can reliably close the container.

1. A cap attachment-detachment device comprising:
a rotation driver that is rotatable in a first direction and a second direction that are opposite to each other;
an operation portion that, when a cap is attached to a container, grips the cap while abutting against a top surface of the cap in which threads are formed, and causes the gripped cap to abut against the container;
a transmitter that rotates the operation portion by transmitting rotation of the rotation driver to the operation portion;
a buffer portion that, when the cap is attached to the container, absorbs a pressing force applied from the cap to the operation portion;
a controller that controls work of the rotation driver;
a base portion;
a holder that holds the operation portion; and
a mover that moves the holder in one direction with respect to the base portion in response to rotation of the rotation driver, wherein
the mover includes a linear-motion ball screw member having a same pitch as a pitch of the cap,
the controller, when the cap is attached to the container, sequentially executes
first control in which the cap gripped by the operation portion is fastened to the container by rotation of the rotation driver in the first direction,
second control in which the cap gripped by the operation portion is loosened from the container by rotation of the rotation driver in the second direction, and
third control in which the cap gripped by the operation portion is fastened to the container by rotation of the rotation driver in the first direction.

2. The cap attachment-detachment device according to claim 1, wherein
the controller causes the cap to rotate by an angle equal to or larger than a pitch angle of the cap in the second control.

3. The cap attachment-detachment device according to claim 1, wherein
in the second control, the controller causes the cap to rotate by an angle that is defined such that the cap is not separated from the container.

4. The cap attachment-detachment device according to claim 1, wherein
when the cap is attached to the container, the rotation driver causes the cap to abut against the container by moving the operation portion.

5-6. (canceled)

7. The cap attachment-detachment device according to claim 1, wherein
the operation portion includes
a pressing member configured to be abuttable against the top surface of the cap, and
a first grip claw and a second grip claw that are opposite to each other with a space below the pressing member interposed between the first grip claw and the second grip claw.

8. The cap attachment-detachment device according to claim 1, further comprising a restricting portion that, when the cap is attached to the container, restricts a torque to be applied to the cap by the operation portion.

9. The cap attachment-detachment device according to claim 8, wherein
the operation portion includes a grip portion that grips the cap, and a driven portion to which the grip portion is connected and which rotates when rotation of the rotation driver is transmitted by the transmitter.

10. The cap attachment-detachment device according to claim 9, wherein
the driven portion includes
a first driven member to which rotation of the rotation driver is transmitted by the transmitter, and
a second driven member to which the grip portion is connected, and
the restricting portion, when the cap is attached to the container, connects the first driven member and the second driven member to each other such that a torque to be transmitted from the first driven member to the second driven member is restricted.

11. The cap attachment-detachment device according to claim 1, wherein
a plurality of the operation portions and a plurality of the buffer portions are provided to correspond to a plurality of the caps, and
the transmitter rotates each operation portion by transmitting rotation of the rotation driver to the plurality of the operation portions.

12. A pre-processing device comprising:
the cap attachment-detachment device according to claim 1 that attaches a cap to and detaches the cap from a container; and
a pre-processor that executes a pre-process on a sample contained in the container.

13. (canceled)

14. A cap attachment-detachment device comprising:
a rotation driver that is rotatable in a predetermined direction;
an operation portion including a grip portion having a pointed tip;
a transmitter that rotates the operation portion by transmitting rotation of the rotation driver to the operation portion;
a controller that, when a cap is detached from a container, controls work of the operation portion such that the tip of the grip portion abuts against the cap in which threads are formed;
a base portion;
a holder that holds the operation portion; and
a mover that moves the holder in one direction with respect to the base portion in response to rotation of the rotation driver, wherein
the mover includes a linear-motion ball screw member having a same pitch as a pitch of the cap.

15. The cap attachment-detachment device according to claim 14, wherein
the controller, after the tip of the grip portion abuts against the cap, further controls work of the operation portion such that control in which the tip of the grip portion is separated from the cap and control in which the tip of the grip portion abuts against the cap again are executed once or more.

16. A cap attachment-detachment device comprising:
a rotation driver that is rotatable in a first direction and a second direction that are opposite to each other;
an operation portion that, when a cap is attached to a container, grips the cap in which threads are formed and causes the gripped cap to abut against the container;
a transmitter that rotates the operation portion by transmitting rotation of the rotation driver to the operation portion;
a controller that, when the cap is attached to the container, controls work of the rotation driver such that the operation portion rotates in the first direction and the cap is fastened to the container;
a base portion;
a holder that holds the operation portion; and
a mover that moves the holder in one direction with respect to the base portion in response to rotation of the rotation driver, wherein
the mover includes a linear-motion ball screw member having a same pitch as a pitch of the cap, wherein
the controller further controls work of the operation portion such that, after the cap is fastened to the container, control in which the operation portion rotates in the second direction and the cap is detached from the container and control in which the operation portion rotates in the first direction and the cap is fastened to the container again, are executed once or more.

17. (canceled)
